(19) United States
(12) Patent Application Publication
(10) Pub. No.: US 2021/0061028 A1
(43) Pub. Date: Mar. 4, 2021

(54) Apparatus and method for vehicular monitoring, analysis, and control

(71) Applicants: Lynn Da Deppo, Bloomfield Hills, MI (US); Marcello Tedesco, Fairhope, AL (US); Carl H. Schell, Waterford, MI (US); Jeffrey T. Root, Howell, MI (US); Ehab Kamal, Renton, WA (US)

(72) Inventors: Lynn Da Deppo, Bloomfield Hills, MI (US); Marcello Tedesco, Fairhope, AL (US); Carl H. Schell, Waterford, MI (US); Jeffrey T. Root, Howell, MI (US); Ehab Kamal, Renton, WA (US)

(73) Assignee: Applied Mechatronic Products

(21) Appl. No.: 16/974,026

(22) Filed: Sep. 11, 2020

Related U.S. Application Data
(63) Continuation-in-part of application No. 16/350,278, filed on Oct. 25, 2018.
Application No. 16/350,278 is a continuation-in-part of application No. 16/350,281, filed on Oct. 25, 2018.
Application No. 16/350,281 is a continuation-in-part of application No. 16/350,273, filed on Oct. 25, 2018.
Application No. 16/350,273 is a continuation-in-part of application No. 16/350,283, filed on Oct. 25, 2018.
Application No. 16/350,283 is a continuation-in-part of application No. 16/350,285, filed on Oct. 25, 2018.
(60) Provisional application No. 62/973,099, filed on Sep. 16, 2019.
(60) Provisional application No. 62/707,265, filed on Oct. 26, 2017.

(51) Int. Cl. B60C 23/00; G06N 20/00; B60C 23/16

(52) U.S. Cl. CPC B60C 23/002; B60C 23/16; B60C 23/009; G06N 20/00

(57) ABSTRACT

A vehicle tire inflation system includes a central gas supply system configured for distribution of inflation gas to a vehicle tire and a distributed gas supply system configured for compressing gas and supplying the compressed gas to a vehicle tire.

### RELATED APPLICATIONS

This application is a continuation in part of U.S. patent applications: APPARATUS AND METHOD FOR VEHICLE WHEEL-END GENERATOR, application Ser. No. 16/350,278; APPARATUS AND METHOD FOR VEHICLE WHEEL-END FLUID PUMPING, application Ser. No. 16/350,281; APPARATUS AND METHOD FOR VEHICULAR MONITORING, ANALYSIS AND CONTROL OF WHEEL-END SYSTEMS, application Ser. No. 16/350,273; APPARATUS AND METHOD FOR AUTOMATIC TIRE INFLATION SYSTEM, application Ser. No. 16/350,283; APPARATUS AND METHOD FOR VEHICULAR MONITORING, ANALYSIS, AND CONTROL, application Ser. No. 16/350,285, all of which were filed on Oct. 25, 2018 and which claim benefit of U.S. Provisional Application entitled, VEHICLE MONITORING, ANALYSIS AND ADJUSTMENT SYSTEM,” Application No. 62/707,265, filed Oct. 26, 2017; this application also claims benefit of U.S. Provisional Application entitled, Apparatus and Method for Vehicular Monitoring, Analysis, and Control, Application No. 62/973,099 the contents of all which are hereby incorporated by reference in their entirety.

### BACKGROUND

Inventive concepts relate generally to a system and method for monitoring and adjusting vehicle characteristics. In particular, inventive concepts relate to a system and method for monitoring; inflating; maintaining tire and wheel related parameters, including air pressure and other parameters; analyzing related data and employing the related data for vehicle operation and maintenance.

Underinflated tires can adversely affect vehicle performance through reduced handling characteristics, lower fuel economy, increased tire wear, road side break downs, etc. However, insuring proper tire inflation is time-consuming and can be a dirty and difficult task. Tire Pressure Monitoring Systems (TPMS) have been proposed as a means of monitoring tire pressure and advising an operator of the state of pressurization in a tire when the pressure is below a target pressure level. Typically, such monitoring systems merely provide an indication of tire pressure inflation level; they do not resolve a tire inflation issue. To address an improper inflation issue, the vehicle must be stationary and proper inflation equipment (both inflation and measuring equipment) must be available, and they often are not.

Although automatic tire inflation systems (ATIS) are available, these systems are costly and difficult to install, particularly for vehicles such as large trucks. Such systems may require specially-ordered attaching equipment, such as custom drive axles. They also, typically, require an extended amount of installation time, making retrofitting an arduous and costly task. These systems do not provide tire status information; they generally maintain targeted tire pressures by pumping air from a reservoir into a tire as the tire's air pressure falls below targeted levels.

### SUMMARY OF THE INVENTION

In example embodiments in accordance with principles of inventive concepts a vehicle monitoring, analysis, and control system may include a wheel-end unit positioned on a wheel-end of a vehicle to generate electrical power, to provide high-frequency sensing and monitoring of wheel-end parameters, to analyze wheel-end health and functionality, and to provide real-time control of wheel functions, such as tire inflation and load balancing.

The system may also provide communications among wheel-end units, between a wheel-end unit and a vehicle-located controller, between a wheel-end unit and a vehicle operator, between a wheel end unit and a vehicle-related third party, such as a dispatcher, vehicle management personnel, or vehicle maintenance personnel, or between a vehicle-located controller and a vehicle-related third party, such as a telematics service. A vehicle-located controller may combine information from wheel-end units with information from other vehicle-located sensors and systems, to integrate wheel-end information with engine-related, cab-related, and other vehicle information systems, for example. The vehicle-related controller may be included in a component referred to herein as a “hub.”

Communications may be related to raw, sensed, data related to a unit associated with the vehicle (for example, a vehicle with a wheel-end unit attached), to analyzed data, or to recommendations or predictions based upon the analysis of data. The raw data may be from sensors related to vehicle parameters, including the operation of various vehicle components, including tires, brakes, bearings, axles, vehicle acceleration, including forward, reverse, and angular, vehicle fuel consumption and current fuel load, current, past, and future locations, route travelled, time in a location, or any other measureable vehicle-related parameter. The raw data may also include such things as the performance and health of the hub unit itself, including such things as compressor performance, state of the air filter, state of the battery, electrical generator performance, pendulum performance, and health, and any detected anomalies. The raw data may additionally include other vehicle parameters our systems can monitor, such as driver performance such as excessive speed, speed consistency, starts and stops, accelerations, jerk (first derivative of acceleration), load conditions, road conditions, tire conditions, environmental conditions, traffic flow (by monitoring hub odometer readings over time), onboard temperature to name some.

Communications may also be related to reduced, or analyzed, raw data that may pertain to vehicle operation and performance, to operator performance, or to environmental factors. Analyses related to vehicle operation and performance may include analyses of sensor data to provide vehicle, operator, environmental (for example, road surface) analyses that provide operation information that may be employed locally (i.e., within the vehicle) or remotely (e.g., at a maintenance, dispatch, or fleet headquarters facility). Operation information may be related to: load balance; load shifting; operator performance (safe operation, efficient operation, vehicle care, etc.); road conditions including surface conditions such as iciness, standing water, surface defects such as potholes, etc.; traffic conditions (information may be shared with a remote entity, such as a dispatcher facility, that can recommend alternate routes based upon input from one or more vehicle systems); and vehicle safety (tire delamination or brake failure, for example). Communications related to information sent from the system to a remote, that is, off-vehicle, entity may also be reflected in information provided by the remote entity to the system, in the form, for example, of recommendations to an operator for refueling, for alternate routes, or for routine or emergency maintenance or repairs, for example. Upon receipt of information from a system in accordance with principles of inventive concepts, a remote entity, such as a maintenance facility, may dispatch maintenance personnel to the vehicle and may notify the operator of such dispatch, in order to prevent or ameliorate the consequences of failures, such as tire delamination, for example.

In example embodiments, analysis may include the use of machine learning that may be implemented using, for example, analog, digital, software, or firmware elements and may employ any of a number of machine learning processes and devices, including, but not limited to: a convolutional neural network, an artificial neural network, a Hopfield network, Baysesian networks, a Markov Chain Monte-Carlo method, for example, trained for analysis and, or, classification, based on sensor measurements, such as acceleration, angular rotation, temperature, and pressure fluctuations associated with a tire, as determined over a period of time, for example.

In example embodiments a vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations, within each monitoring, and analysis and control system and among a plurality of such systems mounted on an individual vehicle.

In example embodiments a system may perform latitudinal and longitudinal analyses of wheel-end functionality, providing diagnostics and prognostics for a wheel-end and for a vehicle associated therewith. In example embodiments Applicants' system generates its own electrical power, and electrical power is always available while the vehicle is in motion. Because the system provides electrical energy storage, electrical energy is also available during periods of vehicle idleness. As previously noted, the constant availability of electrical power permits the system to continuously sense, at a high frequency, various vehicle parameters. The collected body of sensor readings allows the system to analyze wheel-end and vehicle performance in a manner far beyond the conventional detection of low tire-pressure. Applicants' system and method may perform extremely complex and accurate analyses in both the time and frequency domain. Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as controlling optimum tire inflation and load-balancing. The system's diagnostics may, for example, provide an indication of wheel-end “health” or overall performance of the vehicle, diagnose various issues, and extend the lives of tires, of the wheel-end and of the system itself. In example embodiments such measurements analyses and control include measurements and analyses among a plurality of wheel-end units mounted on the same vehicle. All of this is directed to improving the overall safety, economy, and endurance of the wheeled vehicle.

In example embodiments a system may employ the system's detailed sensing, analyses, and diagnostics to provide real-time control of wheel-end functions, such as tire-pressure adjustment (raising or lowering the pressure) and load balancing. In example embodiments such measurements analyses and control include measurements and analyses among a plurality of wheel-end units mounted on the same vehicle.

In example embodiments a system may include a communications system that allows communications among wheel-end units, between wheel-end units and a vehicle central unit processor and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, for example. A sensor complement may include tire pressure, tire temperature, audio sensors, accelerometer, Hall Effect sensor and moisture sensors, for example.

In example embodiments a monitoring system for attachment to a wheeled vehicle wheel-end includes a sensor to sense a physical characteristic of a vehicle to which the monitoring system is attached; a controller to collect readings from the sensor; and the controller to employ the sensor readings to analyze operation of the vehicle. In example embodiments such measurements analyses and control include measurements and analyses among a plurality of wheel-end units mounted on the same vehicle.

In example embodiments a monitoring system for attachment to a wheeled vehicle wheel-end includes the analysis of sensor readings including trend analysis. In example embodiments such measurements analyses and control include measurements and analyses among a plurality of wheel-end units mounted on the same vehicle.

In example embodiments a monitoring system for attachment to a wheeled vehicle wheel-end includes the analysis of sensor readings including the diagnosis of the functionality of the monitoring system. In example embodiments such measurements analyses and control include measurements and analyses among a plurality of wheel-end units mounted on the same vehicle.

In example embodiments a monitoring system for attachment to a wheeled vehicle wheel-end include's the analysis of sensor readings including the diagnosis of the functionality of the vehicle. In example embodiments such measurements analyses and control include measurements and analyses among a plurality of wheel-end units mounted on the same vehicle.

In example embodiments a monitoring system for attachment to a wheeled vehicle wheel-end includes the diagnoses of the functionality of the vehicle including diagnosing the physical state of a vehicle, such as the pressurization state of a tire associated with a wheel-end to which the monitoring system is attached, alignment of a vehicle axle, brake drag in the vehicle, potential delamination of a tire associated with the vehicle, “out-of-round” or other damage to a wheel on the vehicle, for example. In example embodiments such measurements analyses and control include measurements and analyses among a plurality of wheel-end units mounted on the same vehicle.

In example embodiments a monitoring system for attachment to a wheeled vehicle wheel-end includes the diagnoses of the functionality of the vehicle includes diagnosing the pressurization state of a plurality of tires associated with a wheel-end to which the monitoring system is attached. In example embodiments such measurements analyses and control include measurements and analyses among a plurality of wheel-end units mounted on the same vehicle.

In example embodiments a monitoring system for attachment to a wheeled vehicle wheel-end includes the diagnosis of the functionality of the vehicle including diagnosing the state of an axle associated with the wheel-end to which the monitoring system is attached. In example embodiments such measurements analyses and control include measurements and analyses among a plurality of wheel-end units mounted on the same vehicle.

In example embodiments a monitoring system for attachment to a wheeled vehicle wheel-end includes the diagnosis of the functionality of the vehicle including diagnosing the state of bearing associated with the wheel-end to which the monitoring system is attached. In example embodiments such measurements analyses and control include measurements and analyses among a plurality of wheel-end units mounted on the same vehicle.

In example embodiments a monitoring system for attachment to a wheeled vehicle wheel-end includes a controller configured to prognosticate, or predict, changes in the vehicle. In example embodiments such measurements analyses and control include measurements and analyses among a plurality of wheel-end units mounted on the same vehicle.

In example embodiments a monitoring system for attachment to a wheeled vehicle wheel-end includes a controller configured to predict when a tire associated with the wheel-end to which the monitoring system is attached should be replaced. In example embodiments such measurements analyses and control include measurements and analyses among a plurality of wheel-end units mounted on the same vehicle.

In example embodiments a method of a monitoring system for attachment to a wheeled vehicle wheel-end includes a sensor to sense a physical characteristic of a vehicle to which the monitoring system is attached; a controller to collecting readings from the sensor; and the controller employing the sensor readings to analyze operation of the vehicle. In example embodiments such measurements analyses and control include measurements and analyses among a plurality of wheel-end units mounted on the same vehicle.

In example embodiments a method of a monitoring system for attachment to a wheeled vehicle wheel-end includes the analysis of sensor readings including trend analysis. In example embodiments such measurements analyses and control include measurements and analyses among a plurality of wheel-end units mounted on the same vehicle.

In example embodiments a method of a monitoring system for attachment to a wheeled vehicle wheel-end includes an analysis of sensor readings including diagnosis of the functionality of the monitoring system. In example embodiments such measurements analyses and control include measurements and analyses among a plurality of wheel-end units mounted on the same vehicle.

In example embodiments a method of a monitoring system for attachment to a wheeled vehicle wheel-end includes the analysis of sensor readings including the diagnosis of the functionality of the vehicle. In example embodiments such measurements analyses and control include measurements and analyses among a plurality of wheel-end units mounted on the same vehicle.

In example embodiments a method of a monitoring system for attachment to a wheeled vehicle wheel-end includes the diagnoses of the functionality of the vehicle including diagnosing the pressurization state of a tire associated with a wheel-end to which the monitoring system is attached. In example embodiments such measurements analyses and control include measurements and analyses among a plurality of wheel-end units mounted on the same vehicle.

In example embodiments a method of a monitoring system for attachment to a wheeled vehicle wheel-end includes the diagnoses of the functionality of the vehicle including diagnosing the pressurization state of a plurality of tires associated with a wheel-end to which the monitoring system is attached. In example embodiments such measurements analyses and control include measurements and analyses among a plurality of wheel-end units mounted on the same vehicle.

In example embodiments a method of a monitoring system for attachment to a wheeled vehicle wheel-end includes the diagnoses of the functionality of the vehicle including diagnosing the state of an axle associated with the wheel-end to which the monitoring system is attached. In example embodiments such measurements analyses and control include measurements and analyses among a plurality of wheel-end units mounted on the same vehicle.

In example embodiments a method of a monitoring system for attachment to a wheeled vehicle wheel-end includes the diagnosis of the functionality of the vehicle including diagnosing the state of bearing associated with the wheel-end to which the monitoring system is attached. In example embodiments such measurements analyses and control include measurements and analyses among a plurality of wheel-end units mounted on the same vehicle.

In example embodiments a method of a monitoring system for attachment to a wheeled vehicle wheel-end includes a controller to prognosticating, or predicting, changes in the vehicle. In example embodiments such measurements analyses and control include measurements and analyses among a plurality of wheel-end units mounted on the same vehicle.

In example embodiments a method of a monitoring system for attachment to a wheeled vehicle wheel-end includes a controller predicting when a tire associated with the wheel-end to which the monitoring system is attached should be replaced.

In example embodiments a wheel-end system may employ a controller and sensors to determine parameter values, including: tire pressure, temperature, vibration levels, and wheel rotation, for example to control inflation levels in a tire associated with the wheel end. A wheel-end system may employ a mechanical actuation system to react to existing pressure within a tire or pair of tires and to inflate or deflate a tire according to a predetermined setting.

In example embodiments a wheel end system may employ mechanical and electrical control elements that are modular insofar as they may employ a common interface.

In example embodiments a wheel-end system includes a controller to employ any one of, or a combination of, raw sensor data, analysis results, or historic performance, for example, to communicate system status and recommendations to the vehicle operator and/or vehicle responsible maintenance personnel. In example embodiments such measurements analyses and control include measurements and analyses among a plurality of wheel-end units mounted on the same vehicle.

In example embodiments a wheel-end system includes a controller that controls the generation and transmission of energy and determines a state of the system based upon temperature and vibration measurements. In example embodiments such measurements analyses and control include measurements and analyses among a plurality of wheel-end units mounted on the same vehicle.

In example embodiments a wheel-end system includes a controller that determines the rotational speed of the system. In example embodiments such measurements analyses and control include measurements and analyses among a plurality of wheel-end units mounted on the same vehicle.

In example embodiments a wheel-end system includes a controller that determines the number of rotations undergone for a given period. In example embodiments such measurements analyses and control include measurements and analyses among a plurality of wheel-end units mounted on the same vehicle.

In example embodiments a wheel-end system includes a controller that determines the number of rotations undergone for a given period using a Hall Effect sensor. In example embodiments such measurements analyses and control include measurements and analyses among a plurality of wheel-end units mounted on the same vehicle.

In example embodiments a wheel-end system includes a controller that determines the number of rotations undergone for a given period using phase fluctuations of the signal developed by the rotation of the generator shaft. In example embodiments such measurements analyses and control include measurements and analyses among a plurality of wheel-end units mounted on the same vehicle.

In example embodiments a wheel-end system includes a controller that determines the number of rotations undergone for a given period using power generator signal phases as a redundant and/or backup check on actual direct sensors, or may be used in lieu of direct sensors to determine tire rotations and vehicle speed. In example embodiments such measurements analyses and control include measurements and analyses among a plurality of wheel-end units mounted on the same vehicle.

In example embodiments a wheel-end system includes a controller that uses accelerometer sensor data that is collected and analyzed both individually and in comparison, to other system inputs and/or collected data providing early notification capabilities for such things as tire anomalies, developing wheel end issues, road induced wheel damage, etc. In example embodiments such measurements analyses and control include measurements and analyses among a plurality of wheel-end units mounted on the same vehicle.

In example embodiments a wheel-end system includes a controller that determines the existence of a bent wheel by analysis of relative wheel and tire parameter measurements and comparison to a marginally acceptable data trace. In example embodiments such measurements analyses and control include measurements and analyses among a plurality of wheel-end units mounted on the same vehicle.

In example embodiments a wheel-end system includes a controller that determines whether a wheel is out of round, based on vibrational assessment versus a comparison to vibrational signatures of a marginally acceptable wheel. In example embodiments such measurements analyses and control include measurements and analyses among a plurality of wheel-end units mounted on the same vehicle.

In example embodiments a wheel-end system includes a controller that determines whether a vehicle axle is out of alignment by comparing relative measurements from axle to axle on the same vehicle for parameters such as wheel speed, wheel turns per mile etc. In example embodiments such measurements analyses and control include measurements and analyses among a plurality of wheel-end units mounted on the same vehicle.

In example embodiments a wheel-end system includes a controller that detects brake drag or similar abnormalities which may cause slowing of a wheel are detected through parameter measuring, and the comparing of such data, both across axle, and axle to axle to provide a determination. Measured parameters would include wheel rotational speed, temperatures, rate of change and steady state, etc. In example embodiments such measurements analyses and control include measurements and analyses among a plurality of wheel-end units mounted on the same vehicle.

Wheel drum warpage may cause the vibration of a wheel and lead to failure. A wheel-end system may detect wheel drum warpage by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect wheel drum warpage or “ovality” from such measurements and analyses.

Wheel drum damage or cracking may cause the vibration of a wheel and lead to failure. A wheel-end system may detect wheel drum damage or cracking by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect wheel drum damage or cracking from such measurements and analyses.

Improper slack adjuster brake positioning may, under brake application, reduce the rate of deceleration and may lead to accidents. A wheel-end system may detect a disadvantageous slack adjuster position by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and determine slack adjuster performance from such measurements and analyses.

A loose wheel, which may be caused by improper installation, may cause vibration of the wheel and may lead to damage of a vehicle or an accident. A wheel-end system may detect a loose wheel by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect a loose wheel from such measurements and analyses.

Hub failure may cause the vibration of a wheel and lead to failure. A wheel-end system may detect hub failure by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect hub failure from such measurements and analyses.

Bearing failure may cause the vibration of a wheel and lead to failure. A wheel-end system may detect bearing failure by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect bearing failure from such measurements and analyses.

Brake imbalance may cause the vibration of a wheel and lead to failure. A wheel-end system may detect brake imbalance by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect brake imbalance from such measurements and analyses.

Brake fade may result from the increased temperature of a wheel and lead to failure. A wheel-end system may detect brake fade by measuring and comparing sensor data and analyses across an axle (data and analyses from two wheel-end systems, for example) and axle to axle (data and analyses from four or more wheel-end systems, for example). In example embodiments a wheel-end system may measure or calculate wheel rotational speed, temperatures, rate of change of speed and steady state speed, for example, and may include measurements and analyses among a plurality of wheel-end units mounted on the same vehicle and detect brake fade from such measurements and analyses.

In example embodiments a wheel-end system includes a controller that determines pending tire delamination based on acceleration signatures of wheels that are continually monitored and compared to an exemplary data set as well as other wheel/tire sets on the vehicle to identify tires susceptible to such near-term delamination. In example embodiments such measurements analyses and control include measurements and analyses among a plurality of wheel-end units mounted on the same vehicle.

In example embodiments a wheel-end system includes a controller that collects accelerometer data and analyzes both individually as well as in comparison to other system inputs and comparative analysis providing early notification capabilities for such things as tire anomalies, developing wheel end issues, and road induced wheel damage, etc. In example embodiments such measurements analyses and control include measurements and analyses among a plurality of wheel-end units mounted on the same vehicle.

In example embodiments a vehicle tire inflation system, includes a central gas supply system configured for distribution of inflation gas to a vehicle tire and a distributed gas supply system configured for compressing gas and supplying the compressed gas to a vehicle tire.

In example embodiments a vehicle tire inflation system includes a central gas supply wherein the central gas supply system including a storage tank for holding compressed gas to be distributed to a vehicle tire.

In example embodiments a vehicle tire inflation system includes a central gas supply wherein the central gas supply system and distributed gas supply system are configured to supply compressed gas to the same vehicle tire.

In example embodiments a vehicle tire inflation system a central gas supply system and distributed gas supply system are each configured to supply compressed gas to a plurality of vehicle tires.

In example embodiments a vehicle tire inflation system a wheel-end supporting a tire configured to receive compressed gas from a central gas supply system includes a rotary valve for transfer of compressed gas from the storage tank to a vehicle tire.

In example embodiments a vehicle tire inflation system a distributed gas supply system includes a compressor configured to compress air and to supply the compressed air to a vehicle tire.

In example embodiments a vehicle tire inflation system a system includes a manifold for distribution of compressed air from a compressor and compressed gas from a storage tank to a vehicle tire.

In example embodiments a vehicle tire inflation system includes a sensor; and a controller, wherein the sensor and controller are configured for attachment to a wheel-end that supports a tire configured for inflation by the tire inflation system.

In example embodiments a vehicle tire inflation system a sensor is configured to sense a characteristic of the wheel-end or tire attached thereto.

In example embodiments a vehicle tire inflation system a controller is configured to control operation of the compressor.

In example embodiments a vehicle tire inflation system includes a central gas supply system configured for distribution of compressed inflation gas to a plurality of vehicle tires and a distributed gas supply system configured for compressing gas and supplying the compressed gas to a plurality of vehicle tires, wherein the distributed gas supply system comprises a plurality of compressors, one for each wheel-end of the vehicle that supports a tire configured for inflation by the inflation system, and a plurality of controllers, one for each compressor, each controller configured to control one of the compressors.

In example embodiments a vehicle tire inflation method of inflating a vehicle tire includes providing a central gas supply system configured for distribution of inflation gas to a vehicle tire and providing a distributed gas supply system configured for compressing gas and supplying the compressed gas to a vehicle tire.

In example embodiments a vehicle tire inflation method of inflating a vehicle tire includes s central gas supply system comprises a storage tank distributes compressed gas to a vehicle tire.

In example embodiments a vehicle tire inflation method of inflating a vehicle tire includes a central gas supply system and distributed gas supply system supply compressed gas to the same vehicle tire.

In example embodiments a vehicle tire inflation method of inflating a vehicle tire includes a central gas supply system and distributed gas supply system that each supply compressed gas to a plurality of vehicle tires.

In example embodiments a vehicle tire inflation method of inflating a vehicle tire includes a compressed gas a transferred from a storage tank to a wheel-end supporting a tire and to a tire through a rotary valve coupled to the wheel-end.

In example embodiments a vehicle tire inflation method of inflating a vehicle tire includes a compressor in the distributed gas system compresses air to supply the compressed air to a vehicle tire.

In example embodiments a vehicle tire inflation method of inflating a vehicle tire includes a system distributes compressed gas from a storage tank and compressed air from a compressor through a manifold to includes a vehicle tire.

In example embodiments a vehicle tire inflation method of inflating a vehicle tire includes providing a sensor and controller for attachment to a wheel-end that supports a tire configured for inflation by the tire inflation system.

In example embodiments a vehicle tire inflation method of inflating a vehicle tire includes sensor senses a characteristic of the wheel-end or tire attached thereto and the controller controls operation of the compressor.

In example embodiments a vehicle tire inflation system includes a vehicle-based compressed gas source for tire inflation and a controller configured to dynamically control the supply of compressed gas to a vehicle tire.

In example embodiments a vehicle tire inflation system includes a compressed gas source is a centralized compressed gas system including a compressed gas storage tank.

In example embodiments a vehicle tire inflation system includes a compressed gas source is a distributed compressed gas system including a compressor configured to compress gas for inflation of a vehicle tire.

In example embodiments a vehicle tire inflation system includes a controller configured to control the supply of compressed gas to a vehicle tire, responsive to external input to adjust a target inflation pressure.

In example embodiments a vehicle tire inflation system includes controller configured to control the supply of compressed gas to a vehicle tire, responsive to internal input to adjust a target inflation pressure.

In example embodiments a vehicle tire inflation system includes an internal input that includes sensor data and analysis indicative of load conditions.

In example embodiments a vehicle tire inflation system wherein the internal input includes sensor data and analysis indicative of road conditions.

In example embodiments a vehicle tire inflation system wherein the internal input includes sensor data and analysis indicative of environmental conditions.

In example embodiments a vehicle tire inflation system includes a vehicle-based compressed gas source for tire inflation and a plurality of controllers, each configured to dynamically control the supply of compressed gas to a vehicle tire.

In example embodiments a vehicle tire inflation system includes a compressed gas source that is a centralized compressed gas system including a compressed gas storage tank.

In example embodiments a vehicle tire inflation system includes a compressed gas source that is a distributed compressed gas system including a compressor configured to compress gas for inflation of a vehicle tire.

In example embodiments a vehicle tire inflation system includes a controller that is configured to control the supply of compressed gas to a vehicle tire, responsive to external input to adjust a target inflation pressure, the external input including data and analysis from other controllers dynamically controlling the supply of compressed gas to other vehicle tires.

In example embodiments a vehicle tire inflation system includes controller that is configured to control the supply of compressed gas to a vehicle tire, responsive to internal input to adjust a target inflation pressure.

In example embodiments a vehicle tire inflation system includes internal input that includes sensor data and analysis indicative of load conditions.

In example embodiments a method of controlling vehicle tire inflation includes providing a vehicle-based compressed gas source for tire inflation and a controller dynamically controlling the supply of compressed gas to a vehicle tire.

In example embodiments a method of controlling vehicle tire inflation includes a compressed gas source providing a centralized compressed gas supply from a compressed gas storage tank.

In example embodiments a method of controlling vehicle tire inflation includes a compressed gas source providing a distributed compressed gas supply from a compressor configured to compress gas for inflation of a vehicle tire.

In example embodiments a method of controlling vehicle tire inflation includes a controller controlling the supply of compressed gas to a vehicle tire, responsive to external input to adjust a target inflation pressure.

In example embodiments a method of controlling vehicle tire inflation includes a controller controlling the supply of compressed gas to a vehicle tire, responsive to internal input to adjust a target inflation pressure.

In example embodiments a method of controlling vehicle tire inflation includes an internal input that includes sensor data and analysis indicative of load conditions.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a block diagram of an example embodiment of an electronic system that may employ one or more vehicle monitoring, analysis, and control systems in accordance with principles of inventive concepts;

FIG. 2 is a block diagram of an example embodiment of a vehicle monitoring, analysis, and control system in accordance with principles of inventive concepts;

FIGS. 3-4B are views of example embodiments of vehicle monitoring, analysis and control systems installed on vehicles;

FIG. 5 is a front view of an example embodiment of a vehicle monitoring, analysis and control system mounted on a wheel-end;

FIG. 6 is a block diagram of an example embodiment of electrical elements of a vehicle monitoring, analysis, and control system;

FIG. 7 is a more detailed block diagram of an example embodiment of electrical elements of a vehicle monitoring, analysis, and control system;

FIG. 8 is a block diagram of tire inflation components of example embodiments of a vehicle monitor and control system in accordance with principles of inventive concepts;

FIG. 9 is a schematic diagram illustrating a group of eight wheels with associated tires, such as may be found on the rear of a semi-trailer and on which a system in accordance with principles of inventive concepts may be mounted;

FIG. 10 is a perspective view illustrating an example arrangement of a Hall sensor on a rotating element and a magnet located on a non-rotating element of a wheel end unit in accordance with principles of inventive concepts;

FIGS. 11a and 11b depict out-of-alignment and in-alignment axles on a five-axle vehicle, respectively;

FIG. 12 is a flow chart depicting an example process for detection of brake drag, wheel misalignment, or wheel bearing issues in accordance with principles of inventive concepts;

FIG. 13 is a graphical illustration that plots wheel speed vs oscillating amplitude vs vehicle speed;

FIG. 14 is a plot of wheel speed vs oscillating amplitude;

FIG. 15 a sectional view of a dual tire and wheel combination with balancing weights applied;

FIG. 16 is a flow chart illustrating an example embodiment of wheel balancing process in accordance with principles of inventive concepts;

FIG. 17 is a perspective view illustrating the orientation of X, Y and Z axes in relation to a vehicle employing a wheel-end system and associated accelerometer orientations, in accordance with principles of inventive concepts;

FIG. 18 is a plot of acceleration thresholds, illustrating the use of acceleration amplitudes in example embodiments;

FIG. 19 is a plot of acceleration versus time, illustrating the variance of wheel acceleration over time;

FIG. 20 is an example block diagram of a control module, which may employ frequency or other analyses on sensor inputs to continually assess wheel security;

FIG. 21 is an example flow chart illustrating a process flow for vibration analysis in accordance with principles of inventive concepts;

FIG. 22 is a plot of amplitude versus time, representative of data that may be employed in trend analysis in accordance with principles of inventive concepts;

FIG. 23 a frequency plot that illustrates the separation of vibrations from different sources, the separation of frequencies may be employed in example embodiments for the identification of different vibration sources;

FIGS. 24 and 25 provide graphical representations of envelope analysis, such as may be employed in example embodiments;

FIG. 26 is a flow chart that illustrates an example approach to tire tread separation and delamination detection in accordance with principles of inventive concepts;

FIG. 27 is a graphical representation of thresholds set for out of bounds amplitudes such as may be employed in example embodiments;

FIGS. 28 and 29 are plots of acceleration versus time such as may be employed to detect tire delamination in accordance with principles of inventive concepts;

FIG. 30 illustrates the variability of response of an axle from a single tread section encompassing ½ of the tire, increasing as the harmonic frequency of the axle/tire-spring system is approached and decreasing after the area of harmonic frequency is passed;

FIG. 31 illustrates the high side of the harmonic frequency band being reached, with the tire force growing sufficiently to continue to drive the tramp motion of the axle; and

FIG. 32 is a flow chart of an example embodiment of a dynamic pressure adjustment process in accordance with principles of inventive concepts.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to large trucks. Although the following example embodiments focus on examples within the realm of large trucks, other wheeled vehicles, such as off-road vehicles, lift-trucks, industrial trucks, mining vehicles, automobiles, buses, in fact, any wheeled vehicle, are contemplated within the scope of inventive concepts.

The terms first, second, third, etc. may be used herein to describe various elements, components, regions, layers, steps or sections. These elements, components, regions, layers, steps or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

A vehicle monitoring, analysis, and control system in accordance with principles of inventive concepts may include a wheel-end unit positioned on a wheel-end of a vehicle to generate electrical power, to provide high-frequency sensing and monitoring of wheel-end parameters, to analyze wheel-end health and functionality, to provide real-time control of wheel functions, such as tire inflation and load balancing, to provide communications, for example, among wheel-end units, and to provide expandability of sensing capabilities. For brevity and clarity of description, terms “monitoring analysis and control system,” “monitor and control system,” and “wheel-end unit” may be used interchangeably herein and may refer to a wheel-end unit 108, to a plurality of wheel-end units 108, a system that includes additional elements, such as hub 103, or combinations thereof; the proper meaning of the reference should be clear from context.

In example embodiments in accordance with principles of inventive concepts a vehicle monitoring, analysis, and control system may include a wheel-end unit positioned on a wheel-end of a vehicle to generate electrical power, to provide high-frequency sensing and monitoring of wheel-end parameters, to analyze wheel-end health and functionality, and to provide real-time control of wheel functions, such as tire inflation and load balancing.

The system may also provide communications among wheel-end units, between a wheel-end unit and a vehicle-located controller, between a wheel-end unit and a vehicle operator, between a wheel end unit and a vehicle-related third party, such as a dispatcher, vehicle management personnel, or vehicle maintenance personnel, or between a vehicle-located controller and a vehicle-related third party, such as a telematics service. A vehicle-located controller may combine information from wheel-end units with information from other vehicle-located sensors and systems, to integrate wheel-end information with engine-related, cab-related, and other vehicle information systems, for example. The vehicle-related controller may be included in a component referred to herein as a “hub.”

Communications may be related to raw, sensed, data related to a vehicle associated with the vehicle (for example, a vehicle with a wheel-end unit attached), to analyzed data, or to recommendations or predictions based upon the analysis of data. The raw data may be from sensors related to vehicle parameters, including the operation of various vehicle components, including tires, brakes, bearings, axles, vehicle acceleration, including forward, reverse, and angular, vehicle fuel consumption and current fuel load, current, past, and future locations, route travelled, time in a location, or any other measureable vehicle-related parameter.

Communications may also be related to reduced, or analyzed, raw data that may pertain to vehicle operation and performance, to operator performance, or to environmental factors. Analyses related to vehicle operation and performance may include analyses of sensor data to provide vehicle, operator, environmental (for example, road surface) analyses that provide operation information that may be employed locally (i.e., within the vehicle) or remotely (e.g., at a maintenance, dispatch, or fleet headquarters facility). Operation information may be related to: load balance; load shifting; operator performance (safe operation, efficient operation, vehicle care, etc.); road conditions including surface conditions such as iciness, standing water, surface defects such as potholes, etc.; traffic conditions (information may be shared with a remote entity, such as a dispatcher facility, that can recommend alternate routes based upon input from one or more vehicle systems); and vehicle safety (tire delamination or brake failure, for example).

Communications related to information sent from the system to a remote, that is, off-vehicle, entity may also be reflected in information provided by the remote entity to the system, in the form, for example, of recommendations to an operator for refueling, for alternate routes, or for routine or emergency maintenance or repairs, for example. Upon receipt of information from a system in accordance with principles of inventive concepts, a remote entity, such as a maintenance facility, may dispatch maintenance personnel to the vehicle and may notify the operator of such dispatch, in order to prevent or ameliorate the consequences of failures, such as tire delamination, for example.

In example embodiments a system in accordance with principles of inventive concepts may include: an integral ATIS/TPMS, an odometer for each tire or each wheel end, and tire diagnostics and prognostics that provides an indication of whether there is air loss in a tire, what rate of air loss pertains (if any), whether the system can address the air loss with a sufficient supply of air to the leaking tire, and whether the present run can be completed or, if not, how much farther the vehicle may travel safely. This information, too, may be communicated locally, on-vehicle, or remotely, to telematics, maintenance, fleet management, or other entity, for example. Tire delamination, wheel bearing conditions, thermal events, drive/road monitoring may also be monitored and communicated in accordance with principles of inventive concepts.

In example embodiments information and analyses provided by a system in accordance with principles of inventive concepts may allow “grading” of an operator, and such grading may be provided to the driver and/or a third party, such as a dispatching facility, maintenance facility, telematics facility, or fleet supervisory facility, for example. Such grading may involve: correlating the roughness of a given cargo's ride to a customer's damage claims; determining the care with which a driver is operating a vehicle (for example, is the driver managing a route responsibly or “flying” over curbs, railroad tracks, or other obstacles); or correlating civilian complaints to vehicle data and analyses, for example. Break and bearing performance may be monitored and reported on and may be derived from temperature and rotational sensing. Alignment may also be monitored and reported on: axle-to-axle or trailer-to-tractor misalignment can contribute to excessive tire wear and reduce fuel efficiency and example embodiments in accordance with principles of inventive concepts may provide this information, for example, to an operator, maintenance personnel, or fleet managers, for example. Tire tread delamination is a serious issue, with potential for damage, serious injury or even death and example embodiments in accordance with principles of inventive concepts may monitor and report on such issues as well.

In example embodiments a system in accordance with principles of inventive concepts may employ a component that rotates relative to the inertial reference frame of a rotating wheel to form what is referred to herein as an inertial power generator. The inertial power generator may generate electrical power for an electronic monitor analysis and control system in accordance with principles of inventive concepts and may provide power to a mechanical pumping system that provides air to one or more tires associated with a wheel-end. With a system in accordance with principles of inventive concepts attached to a wheel-end, as the vehicle moves a system housing and a portion of internal workings of the system rotate along with the axle and wheel-end with which it is associated. A portion of the system, referred to herein as an inertial electrical power generator, or a portion thereof, does not rotate along with the wheel-end. The differential rotation between the components that rotate along with the wheel-end and the components that do not is employed to generate electrical power. Power conditioning and electrical power storage, such as battery storage, may be employed to provide power to a system processor whether the vehicle associated with the wheel-end is moving or not. While the vehicle moves, power is generated by the inertial power generator; while the vehicle is stationary, power may be drawn from the electrical power storage.

A vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations.

Applicants' system may perform latitudinal and longitudinal analyses of wheel-end functionality, providing diagnostics and prognostics for a wheel-end and for a vehicle associated therewith. Because Applicants' system generates its own electrical power, electrical power is always available while the vehicle is in motion. Because the system provides electrical energy storage, electrical energy is also available during periods of vehicle idleness. As previously noted, the constant availability of electrical power permits the system to continuously sense, at a high frequency, various vehicle parameters. The collected body of sensor readings allows the system to analyze wheel-end and vehicle performance in a manner far beyond the conventional detection of low tire-pressure. Applicants' system and method may perform extremely complex and accurate analyses in both the time and frequency domain. Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as controlling optimum tire inflation and load-balancing. The system's diagnostics may, for example, provide an indication of wheel-end “health” or overall performance of the vehicle, diagnose various issues, and extend the lives of tires, of the wheel-end and of the system itself. All of this is directed to improving the overall safety, economy, and endurance of the wheeled vehicle.

Applicants' system may employ the system's detailed sensing, analyses, and diagnostics to provide real-time control of wheel-end functions, such as tire-pressure adjustment (raising or lowering the pressure) and load balancing.

Applicants' system may include a communications system that allows communications among wheel-end units, between wheel-end units and a vehicle central unit processor and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, for example.

A sensor complement may include tire pressure, tire temperature, audio sensors, hub temperature, accelerometer, Hall Effect sensor and moisture sensors, for example.

A wheel-end unit may communicate directly with other wheel-end units associated with the same vehicle, may communicate with other wheel-end units through an intervening hub, or may communicate with other wheel-end units through other communications channels, such as through the cloud. In example embodiments each wheel-end unit includes a controller that may detect accelerometer data to determine from vibration signatures whether the associated wheel is out-of-round by comparing the vibrational signature to the vibrational signature of wheels that are not out of round or by comparing the vibrational signature to the vibrational signature of wheels that are out of round. In example embodiments a wheel-end unit may compare measurements from axle to axle on the same vehicle to determine whether an associated axle is out of alignment (for example, if one wheel turns at a higher rate than another or) or brake dis-function (for example, brake drag or other failure) by comparing wheel rotation rates, temperature, and rate of change, for example. Tire failures, such as impending delamination or bulges, for example, may be determined by comparing wheel-end signatures (based upon sensor data, such as vibration, temperature, and pressure) with example wheel-end signatures that either exhibit such imminent failures (e.g., known bad) or do not exhibit such failures (known good). Such comparisons may also compare signatures from other wheel-end units associated with the same vehicle.

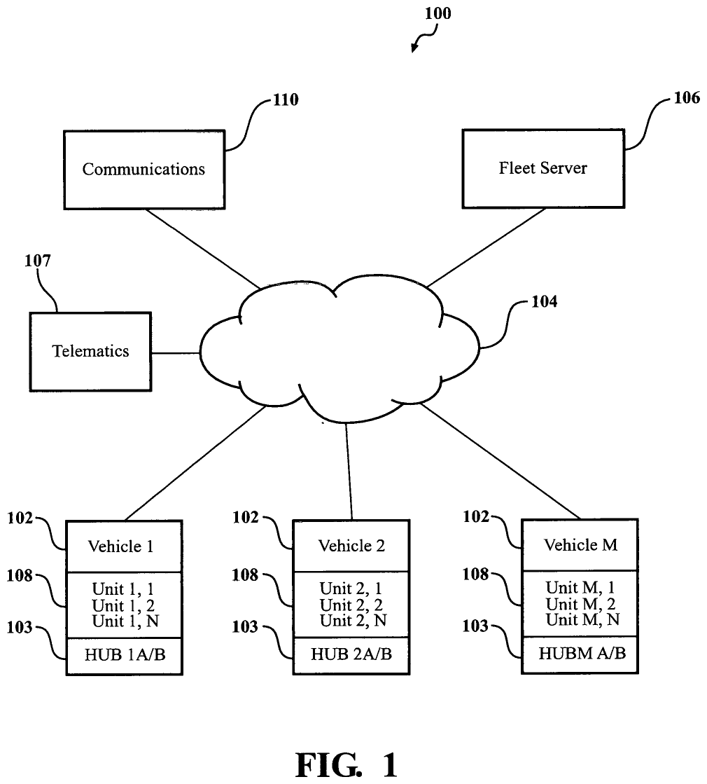

An example embodiment of a vehicle monitor, analysis, and control system 100 in accordance with principles of inventive concepts is illustrated in the block diagram of FIG. 1. In this example embodiment M vehicles 102 each include N wheel-end units 108. The trailer of a semi-trailer truck may include four wheel-end units, one for each dual-tire wheel-end, and the cab may include six, one for each wheel-end, for a total of ten wheel-end units 108 for each semi-trailer/cab combination.

As previously indicated, system 100 and wheel-end units 108 may be used in conjunction with any wheeled vehicle, whether off-road, commercial, industrial, or passenger. Descriptions herein will be directed to use with large trucks, but inventive concepts are not limited thereto.

Each wheel-end unit 108 includes a communications system including a transceiver that may provide communications using any of a variety of technologies and formats, including any wireless communications link such as Bluetooth, WiFi, RFID, infrared, visible or radio-frequency. Each wheel-end unit 108 may include a transceiver that allows the wheel-end unit to communicate with each of the other wheel-end units associated with the same vehicle it is associated with. Each vehicle (the term vehicle includes motorized vehicles, such as a semi-trailer cab and non-motorized vehicles, such as a semi-trailer trailer, for example) may include a hub 103 that may provide communications with all wheel-end units associated with the vehicle and may provide communications, through cloud 104, for example, with one or more fleet servers 106 or one or more portable communications devices 110, which may be a laptop computer, a pad computer, or a cellular telephone, for example. As previously indicated, off-vehicle communications are not limited to portable communications devices 110 or fleet server 106, and may include communications with telematics 107 devices or services, for example. Hub 103 may provide vehicle control functions, such as for controlling an autonomous or remote-controlled vehicle, for example. Fleet server 106 may gather diagnostics and prognostic analysis results provided by one or more wheel-end units 108 and, at least in part, from those results may coordinate maintenance or replacement of vehicle systems or components. Each hub 103 may be associated with a trailer or cab and, in a semi-trailer truck embodiment, the combined vehicles (i.e., trailer and cab) may include two hubs 103, one each for the cab and trailer, or one hub 103 may service both the cab and trailer.

In some embodiments wheel-end units 108 may communicate directly with fleet server 106 through cloud 104 and may include an Internet interface, allowing fleet server 106 or portable communications device 110 to access raw data or analytics (e.g., diagnostics and prognostics) from each wheel-end unit 108, either directly or through hub 103. Diagnostics and prognostics may employ, for example, a frequency domain analysis of nearest-neighbor tires (e.g., tires on the same end of an axle or those on opposing ends of the same axle). Such analysis may be used to determine whether wheels are out of alignment, whether a tire has been damaged, whether road hazards, such as pot-holes or road debris had been encountered, whether other impact events had occurred, whether foreign objects may have become lodged within a tire, or whether tread delamination had begun, for example. Data may be employed, for example, to build or improve models for improved analytics. Tire wear and aging or deterioration of tires may also be detected through analysis in example embodiments. In some embodiments hub 103 may gather, organize and format raw data and analytic results from an associated vehicle for presentation to fleet server 106 or portable communications device 110.

A vehicle monitoring, analysis, and control system in accordance with principles of inventive concepts may be attached to a vehicle's wheel-end to monitor and adjust, for example, the air pressure of a tire associated with the wheel-end to which the system is attached. A plurality of such systems may be employed on a vehicle, with individual systems attached to each vehicle wheel-end. In example embodiments a system in accordance with principles of inventive concepts may include an inertial power generator, a mechanical pumping system and an optional electronic control and communication system. Because the system is attached to a wheel-end, as the vehicle moves the housing and a portion of internal workings of the system rotate along with the axle and wheel-end with which it is associated. A portion of the system, referred to herein as an inertial power generator, or a portion thereof, does not rotate along with the wheel-end.

In example embodiments the inertial power generator includes a quasi-stationary element (also referred to herein as a stationary element) in the form of a weighted pendulum, which is supported by a shaft along a central axis of the system and is free to rotate thereabout. A mechanical coupler (also referred to herein as a transmission system, or, simply, a transmission) couples the quasi-stationary element to the pumping system, which, along with the transmission, rotates with the rotation of the vehicle's wheel. With the coupling and pumping system rotating and the pendulum substantially stationary, the pendulum applies a torque to the transmission, which transfers the torque to the pumping system. In example embodiments, the weighted pendulum is configured to supply sufficient torque to meet demands. That is, the pendulum is sized to, at one extreme, provide sufficient weight that the pendulum would always remain quasi-static (never move) under torque demands of the system, and at the other extreme, be just a bit more than a mass that would cause the pendulum to spin under a torque demand situation, making the system ineffective. The minimum weight of the pendulum must be sufficiently large to drive the systems within the monitoring, analysis and control system accounting for multiple demands including: pumping, meeting other torque demands of the system (e.g. electrical power generation, start-up torques due to inertia, friction; starting vs. running, etc.), possible parasitic loss developments over the life of the system, as well as a performance margin (safety margin). As noted, the pendulum will have demands that are larger than the steady state running torques and these peak torques will drive the sizing of the pendulum mass. The running torques will fluctuate to some degree, as well. The design of the overall system has been structured to minimize the torque requirements. The system is structured to minimize the torque requirements by minimizing of drive torques, while not violating minimum pumping requirements. This may include gear drive ratios other than 1:1, possibly using a 2:1 average gear ratio, or similar type ratio between the drive gear and the driven gear. Additionally, to address the fluctuating torque demands, use of a unique torque transmission system using an elliptical gear system to provide added mechanical advantage at the point of highest compression of the compressor thus reducing fluctuation in the system peak torque demands. A lighter pendulum mass is beneficial in both the weight saving from the mass reduction of the pendulum itself, as well as, the benefits of lowered bearing and structural loading requirements associated with the lower pendulum mass. This translates into improved durability at a lower weight and allowing the collective weight saved to be applied in the transfer of added vehicle cargo.

In example embodiments, the electrical system may include a power source in the form of a primary or secondary battery. In example embodiments in which a secondary battery is used, the electrical system may employ an electrical generator that is coaxial with a system support, with the generator's stator coupled to the system support (thereby rotating with the rotational portion of the system) and the rotor is coupled to the pendulum, thereby remaining substantially stationary; the relative rotation between the stator and rotor generates electricity. Electricity thus-generated may be used by electronics directly (with normal conditioning) or supplied to an electrical storage system, such as a secondary battery. In embodiments in which a primary battery is used, the battery supplies power to the electronics directly and is replaced as needed.

As will be described in greater detail below, the electrical system may include a variety of sensors that are monitored by a controller (such as a microcontroller, for example). The controller obtains data from various sensors and processes the data. The processed data may be stored, analyzed and transmitted. The results of analyses may be used by the controller to control the pumping system in order to inflate an associated vehicle tire, for example or may generate recommended actions, that may be either immediate in nature or of a maintenance ongoing nature associated with the state of the wheel-end, axle system or trailer/tractor in total. This information may be transmitted to the driver or a third party using any of a variety of methods.

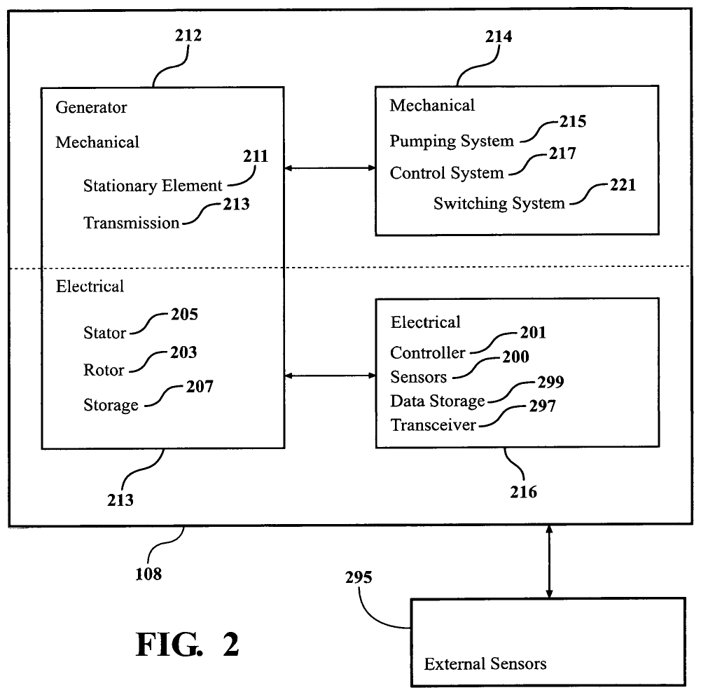

The conceptual block diagram of FIG. 2 provides an overview of an example embodiment of a vehicle monitoring and adjustment system wheel-end unit 108 in accordance with principles of inventive concepts. System wheel-end unit 108 includes a mechanical power generator 212, a mechanical system 214, and electrical power generator 213 an electrical system 216, all of which may be mounted to a vehicle's wheel-end.

Power generator 212 includes quasi-stationary element 211 (a weighted pendulum in example embodiments), which is supported along a central axis of the system on a system support shaft and is free to rotate thereabout. Although free to move about the axis of a shaft, quasi-stationary element 211 remains substantially stationary in its own reference frame, while rotating about the shaft in the reference frame of a substantial portion of the system wheel-end unit 108. Quasi-stationary element 211 may also be referred to herein as stationary element or pendulum, for example. Transmission 213 couples pendulum 211 to mechanical pumping system 215 and mechanical switching system 221, which, along with transmission 213, rotates along with the rotation of the vehicle's wheel.

With the transmission 213 and pumping system 215 rotating and pendulum 211 substantially stationary, the pendulum 211 applies a torque to the transmission 213, which transfers the torque to pumping system 215. The mass size and configuration, and the lever arm length of pendulum 211 are chosen to deliver sufficient torque for pump, and electrical generation actions through a wide range of a vehicle's operating speeds, without excessive travel of the pendulum. In example embodiments power generator 212 includes an electrical generator 213 and electrical storage 207 (also referred to herein, simply, as a “battery”), used to power electrical system 216. In example embodiments, electrical generator 213 is coaxial with a system support shaft, with the generator's stator 205 coupled to the system support (thereby rotating with the rotational portion of the system) and the generator's rotor 203 is coupled to the pendulum 211, thereby remaining substantially stationary; the relative rotation between the stator 205 and rotor 203 generates electricity.

Mechanical system 214 includes mechanical control 217 (including mechanical switching 221), pumping 215, and filtration 219, each of which will be described in greater detail below. Mechanical control system 217 engages transmission 213 with pendulum 211 within a range of operational parameter values and disengages transmission 213 from pendulum 211 outside that range. Pumping system 215 translates rotational movement provided by transmission 213 into linear movement used to operate pistons that compress air for use in maintaining proper tire pressure.

Electrical system 216 may include a controller 201, which may be embodied as microcontroller, or microprocessor and various support electronics, for example. Controller 201 may obtain data from a variety of sensors 200 and operate upon the data for a variety of analytical, control, storage, and transmission functions, as will be described in greater detail below. These sensors may include sensors internal to the monitoring, analysis and control system unit as well as those that may be external to the unit, sensors 295.

The availability of an electrical power generating source within the system affords the opportunity to perform many functions not available with a fixed electrical source that needs to conserve energy. Examples include the ability to sample sensors at much higher rates and for much longer durations than would typically be done in a battery-powered system. Additionally, the presence of a powerful processor, such as a microcontroller (MCU), or System-On-Chip (SOC) within the unit, allows the ability to perform intensive signal processing functions. As an example, sampling of accelerometer data at 16 KHZ can be performed continuously while performing Fast Fourier Transforms (FFT's) or Discrete Fourier Transforms (DFT's) via a 32-Bit MCU on the resulting signals, allowing the gathering of not only accelerometer magnitudes, which indicate things such as pot hole events, but also frequency information which are only available via much more power demanding operations that the aforementioned on-board processor can perform. In some embodiments, the system 108 may employ this data to perform analytics to provide diagnostics and prognostics heretofore unavailable.

For example, the system 108 may sample raw 10-bit or 12-bit data over long intervals (for example, at least one second recordings) at very fast rates (for example, at a minimum of 16 KHZ) to generate a sample file of the accelerometer recording of events that contain an array of precisely timed sensor readings. In this manner, system 108 may extract frequency domain data, rather than, or in addition to, just time domain data. By extracting frequency domain data, system 108 derives the data necessary for it to provide a significantly greater degree of signal processing capabilities, up to and including machine learning processes. With system 108 including a continuous internal power generating source 213, the system may sample numerous sensors, continuously and at a high rate. In example embodiments sampling resolution may most commonly fall within the 8-bit to 24-bit range, for example, with 12-bit resolution most common. Sampling frequency may be determined by a specific sensor's throughput capability, or update rate, but, generally, sampling is done at or above the Nyquist rate for a given sensed characteristic. For example, sampling frequency may be from 1 Hz for relatively slow-changing characteristics to the maximum capabilities of a system controller or sensor output capability. In example embodiments, a sampling rate of from 1 Hz to 16 kHz would be adequate to address many characteristics of interest, such as vibrational characteristics, which are typically manifested within a range of up to 8 kHz. Higher rates may be employed, for example, to sample vibrations within the audible range (for example, sampling at 40 kHz provides loss-free sampling for vibrations up to 20 kHz, the commonly accepted upper limit of the audible range). However, inventive concepts are not limited thereto.

The use of a main processor, controller 201, housed within wheel-end unit 108, allows sampling and analysis at high rates and to the fullest capabilities. Along with this, system 108 performs continuous monitoring and analysis of a variety of functions, components, and performances could generally be described as “wheel-end health.” Such operations may include, for example, monitoring wheel imbalance, which the system 108 detects via frequency domain readings of the accelerometer sensors; comparing the frequency domain results of one wheel, say wheel “A”, to the frequency results of a second wheel, say wheel “B.” Such a comparison, performed by system 108, allows system 108 to better discriminate between environmental effects, such as a bumpy road condition, that all tires may be experiencing, and single events that only one wheel may experience, such as damaging a tire from hitting a curb or pot hole. The processing capabilities of an always-powered system, recording at very high data rates, over long periods of time, and the ability of the wheel-ends to communicate with each other and share their data, allow the creation of a very powerful wheel-end health monitoring system with diagnostic and prognostic capabilities at each wheel-end, assessing performance for wheel-ends, extending to axle assemblies and units in total (e.g. axle alignment, etc.).

The performance and capabilities of a wheel-end unit system 108 may extend beyond the confines of the monitoring, analysis and control system. Sensors 295 may exist external to the monitoring, analysis and control system and utilize the computing power of the monitoring, analysis and control system in assessing the status and health of the environment in the vicinity of the monitoring, analysis and control system and around the vehicle in total. For example, external sensors 295 may include brake system slack adjuster sensors. Such sensors may monitor the performance of a brake system slack adjuster and, as the brake system slack adjuster continually adjusts the brake system as the pads wear and moves into an area that may require vehicle maintenance, the monitoring, analysis and control wheel-end unit system 108 may communicate that knowledge to the appropriate personnel in an appropriate time frame to allow maintenance prior to field issues occurring. For example, a system in accordance with principles of inventive concepts may issue a warning to prevent tire delamination when delamination may be imminent (as indicated by sensor readings and analyses). Such a warning would be particularly beneficial while the vehicle is moving, as delamination can damage the vehicle with the delaminating tire and surrounding vehicles, as well. As noted elsewhere, in example embodiments, a monitor, analysis and control system includes an air-compressor and air filter. By monitoring air filter performance, a system may determine the extent of air compressor wear. Additionally, in example embodiments, a system may monitor the temperature of a generator, or energy harvester, in accordance with principles of inventive concepts to analyze any aging issues that may expressed through temperature and, should aging become an issue, indicate that the generator should be replaced.

An additional example embodiment of the use of external sensors 295 by system 108 may include suspension ride height sensors. These sensors may indicate the ride height of a trailer system and system 108, from the ride height, system 108 may calculate the weight and placement of load within the trailer. In some embodiments system 108 employs data collected from all of the wheel-end unit systems 108 associated with a trailer are analyzed by one or more of the systems 108 calculating the center of gravity within the trailer unit. Having determined the weight and displacement of load within a trailer, in some embodiments system 108 may optimize tire pressure, based upon load conditions (for example, higher pressures for heavier loads and vice versa). In some embodiments, system 108 may also assess and provide recommendations for load placement during the loading process or assess potential load shifts during transit. If system 108 determines that a load has shifted, it may alert a driver or manager, either through an optional local user interface (for example, a display and voice, keyboard, keypad, or soft keypad input) or through the cloud 104 to fleet server 106 or portable communications 110 link previously described. Analysis and control using additional types of external sensors, including pressure, temperature, moisture, sound, light level, air filter performance, etc., are contemplated within the scope of inventive concepts.

An additional example embodiment of the use of external sensors 295 by system 108 may include brake slack adjuster positioning sensors. These sensors may indicate the position of the brake slack adjuster upon brake application of a trailer system, for example. From the position of the brake slack adjuster, system 108 may calculate the amount of travel on the slack adjuster arm and the brake capacity of the trailer. In some embodiments, system 108 may employ data collected from all the wheel end units systems 108 associated with a trailer are analyzed by one or more of the systems 108 calculating the position of the slack adjuster arm within the trailer unit. Having determined the position and displacement of the arm within a trailer, in some embodiments, system 108 may alert a driver or manager, either through an optional local user interface (for example, a display and voice, keyboard, keypad, or soft keypad input) or through the cloud 104 to fleet server 106 or portable communications 110 link previously described. Analysis and control using additional types of external sensors, including pressure, temperature, moisture, sound, light level, air filter performance, etc., are contemplated within the scope of inventive concepts.

Data storage 299 may be used to store raw or processed data, analytical results, or data or commands received from other controllers associated with a vehicle or from a separate, possibly centralized, data source, such as a vehicle data center or fleet server 106. Electronic communications may be implemented through transceiver 297 and may allow a system in accordance with principles of inventive concepts to share data and analyses among a plurality of systems or other electronic devices, including a vehicle operator's electronic system, a vehicle dispatcher, or a maintenance manager, for example.

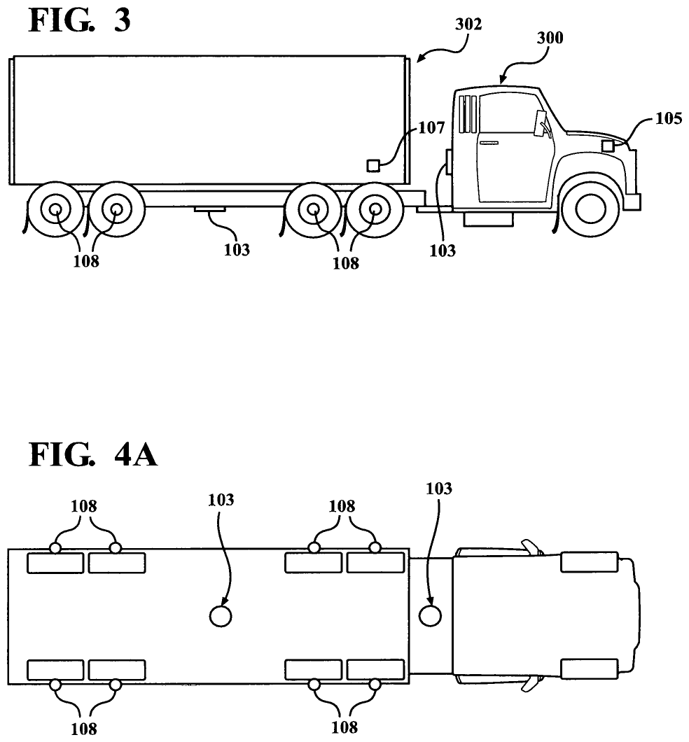

FIG. 3, illustrates, in side view, a plurality of vehicle wheel-end systems 108 in accordance with principles of inventive concepts configured on a vehicle 300. In this example embodiment, the systems 108 are mounted on motored vehicles 300 or trailered units 302 (a tractor 300 and semi-trailer 302 in this example embodiment). The wheel-end systems 108 are shown installed on all tractor (powered and non-powered) and trailered (non-powered) wheel assemblies, though a combination of installed and not installed on some wheel assemblies is contemplated within the scope of inventive concepts (for example, installed on powered axles only, or installed on trailered (non-powered) axles only, or installed on a combination of both trailered (non-powered) and powered wheels or as depicted in the illustration). The systems 108 are installed on wheel-ends and provide a distributed set of vehicle monitoring, analysis, and control systems that, among other things, provide tire pressure monitoring and automatic tire inflation.

In example embodiments, each system 108 may operate autonomously to monitor and adjust vehicle attributes, such as tire pressure, associated with the wheel-end to which they are attached. Additionally, each system 108 may store, process, analyze and transmit or receive information (that is, raw data, analytical results or commands, for example) associated with the wheel-end to which they are attached. Such information may be shared with a central processor, or hub, 103 connected to, or associated with, a vehicle (located in either tractor 300 or trailer 302, for example) or one of the systems 108 may operate as a central processor or hub. Each wheel-end system 108 may provide vehicle monitoring, analysis, and control, including, for example, tire pressure monitoring and pressure adjustment for both single and multiple tire combinations as might be configured on a given wheel-end.

Hub 103 may forward sensed, calculated, or analyzed information generated and/or obtained at the monitoring, analysis and control systems 108 to vehicle operators or logistics/maintenance providers as is instructed or designated by the communications controller 103, and as previously described.

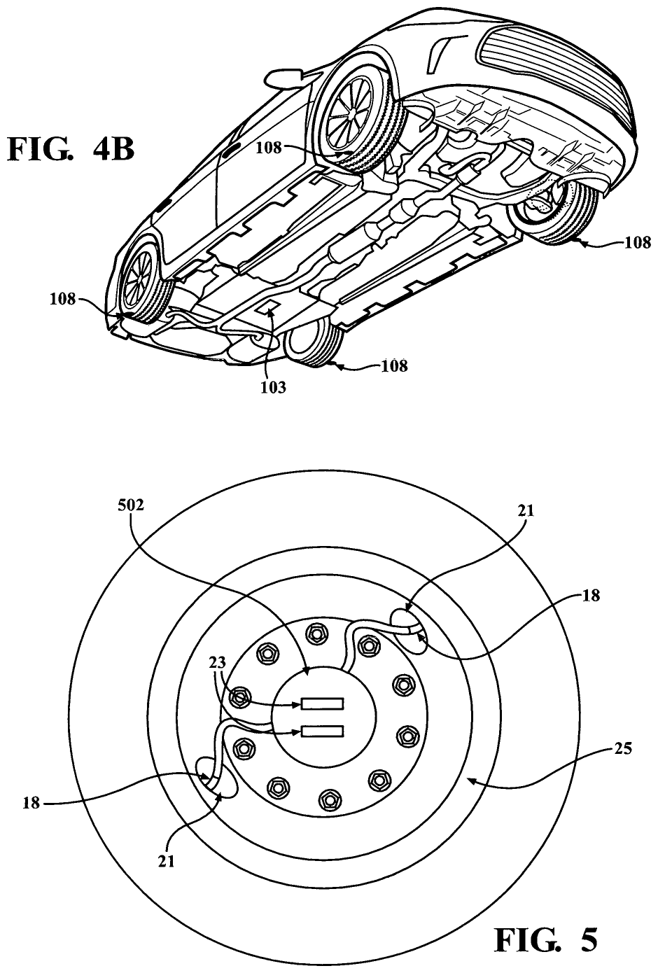

FIG. 4a is a plan view, schematic representation displaying monitoring, analysis and control system systems 108 on both motored 300 and trailered (non-powered) 302 vehicles. (FIG. 4b depicting a similar passenger vehicle representation). A hub unit (103) may be positioned on the motored vehicle 300 or on the trailered vehicle 302. The transmitter/receiver unit (103) may communicate between the individual or collective wheel-end, or, monitoring, analysis and control, systems 108 with the world external to systems 108, for example, as determined by preset protocols defined during the set-up of the system. Programmable system parameters may include, but are not limited to: alert notifications, including the type of item to alert, what person/entity to notify; system parameter settings, including tire pressure setting, security setting (e.g. password, type of unauthorized removal actions, etc.); and systems to activate, including system performance monitoring, diagnostic systems, prognostic systems, for example. In example embodiments, the programing/set-up of the monitoring, analysis and control system systems 108 may be performed via a base unit or, for example, via an application as installed on a portable device 110 such as a smart phone.

FIG. 5 is a close-up view of an example embodiment of a system 108 in accordance with principles of inventive concepts fixed to a wheel 25. The system 108 may provide connection to a reservoir or plurality of reservoirs 20 or connection to a tire 19 or plurality of tires, which may be made through separate fluid transmission devices. These fluid transmission devices may be tubes, hoses (“hose,” 18 as depicted in the FIG. 5 and as referred to hereinafter), or other types of fluid transfer devices connecting system 108 to the outer and inner tires 19a, 19b (illustrated on the rear tires of trailer 302 in FIG. 4a, for example) by way of the air inlet port or valve 21 on each of the tires. The system 108 end of the hose 18 may connect to ports 22 on system 108. The ports 22, in turn, may be connected to controls or sensors within system 108 that may monitor or adjust the air pressure of the tires if the system 108 detects parameter values outside of targeted value ranges, for example. In example embodiments, the tire health monitoring and parameter-altering may be carried out while the vehicle is in motion and does not require the vehicle to be brought to a stop for either the monitoring or the parameter adjustment to occur.

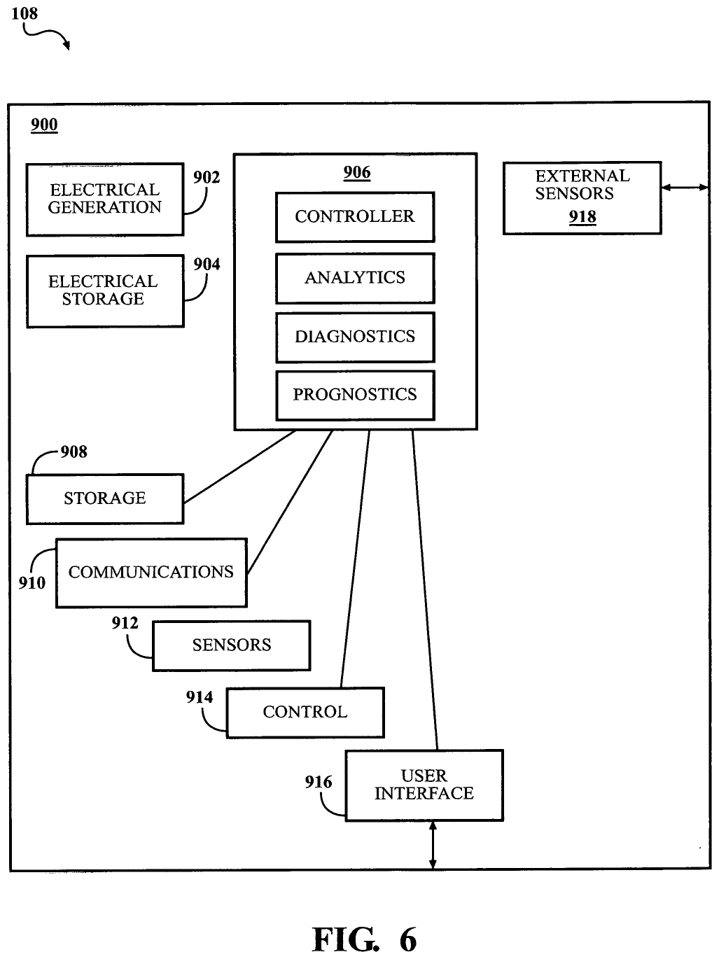

The functional block diagram of FIG. 6 provides a more detailed view of an example embodiment of a wheel-end system 108 in accordance with principles of inventive concepts. System 108 includes an electrical power system 900, controller 906, electronic storage 908, a communications system 910, sensors 912, control electronics 914, a user interface 916, and an external sensor interface 918.

Electrical power system 900 includes electrical power generator 902 (which may be the same as 212 described in relation to FIG. 2) and electrical power storage system 904 (which may be the same as 207 described in relation to FIG. 2).

Electronic storage 908 may include volatile or non-volatile electronic memory, such as ROM, EEPROM, Flash, DRAM, phase-change, or other memory. Electronic storage 908 may store sensor readings; controller calculations, analyses, diagnostics, and prognostics; information obtained through user interface 916 (commands, updates, etc.); information obtained through communications interface 910, such as sensor readings, analytics results, diagnostics and prognostics from one or more other systems 108 associated with the same vehicle as the instant system 108; or information or commands from remote devices, such as fleet server 106 or portable communications device 110, for example, through cloud 104.

Communications interface 910 may employ any of a variety of formats and technologies to provide communications among systems 108 associated with a particular vehicle or, directly or through cloud 104, with portable devices 110 or fleet server 106, for example.

Sensors 912 provide readings on tire pressure, tire temperature, motion (e.g., three dimensional accelerometer), wheel temperature, ambient pressure, ambient temperature, wheel temperature, microphone, distance sensors, color sensors, humidity sensors, altimeters, Hall effect sensors, air flow (e.g., Pitot tube), camera (IR, visible, low-light level, etc.), for example Sensor readings may be employed by controller 906 in analytics, diagnostics and prognostics, as described in greater detail herein.

Control electronics may include electromechanical devices, such as solenoids or solenoid valves, employed by controller 906 to control gas flow into or out of tires to thereby ensure proper tire inflation for load-leveling, for proper tire wear, for fuel efficiency, and for safe vehicle operation, for example. A piston control, for operation of one or more pumps, or control for engagement of a clutch or other mechanism to engage or disengage an energy harvesting, or generator, element, such as a inertial mass or quasi-stationary device described herein.

User interface 916 allows a user, such as a vehicle operator, to securely query, adjust, or command a system 108. Input and output through the user interface 916 may employ audio, touchpad, keyboard, stylus, via a standard interface (e.g., USB port), and display, for example.

Controller 906 may be implemented, at least in part, using a microprocessor, microcontroller, application specific processor, system on a chip, or digital signal processor, for example. Controller 906, in addition to controlling the sampling of sensors 917, performs analyses, diagnostics, and prognostics, as described in greater detail herein.

External sensor interface 918 provides communications with sensors that may be external to system 108 such as a camera, for example.

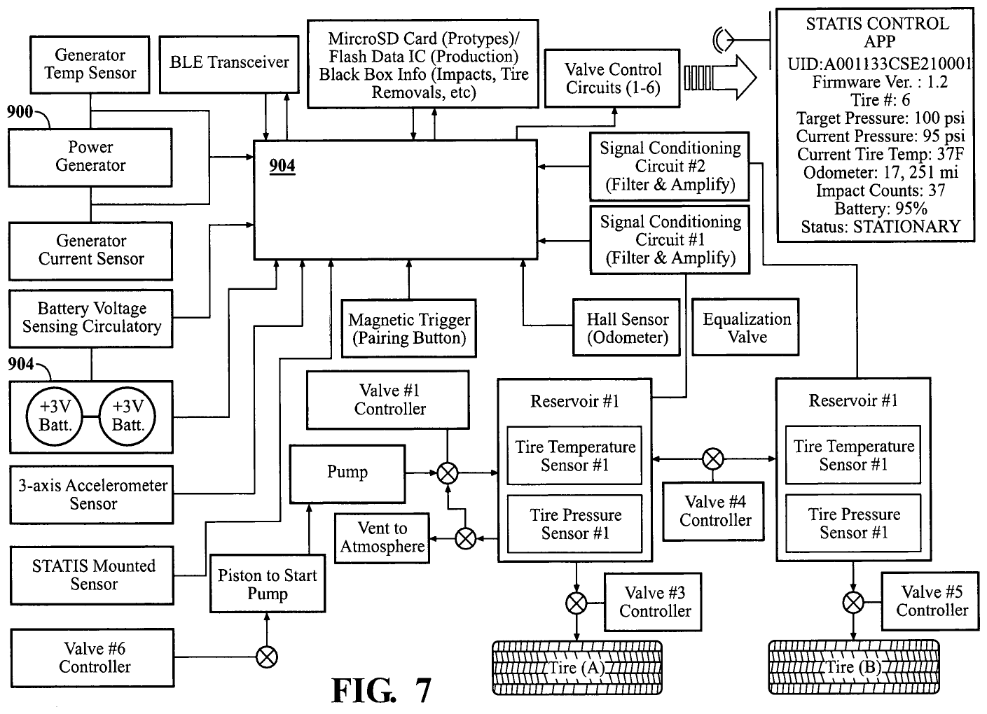

The detailed block diagram of FIG. 7 illustrates a combination of electronics, electromechanical, and mechanical components of system 108, with interfaces to tires (Tire A and Tire B) of a dual-wheel example embodiment. In example embodiments, Statis mounted sensors include slack adjuster inputs and image sensors and BLE refers to a Bluetooth Low Energy transmitter/receiver. In this example embodiment a micro SD card may be used for extended storage during prototyping and a flash card used during production for storing “black box” information, such as impacts (e.g., pothole strikes) and tire removals, for example. Controller 906 employs valve control circuits 1-6 to control a piston (valve 6) to start a pump that employs the previously described mechanical power generator to fill reservoirs 1 and 2, which supply air to tire A and tire B respectively. Controller 906 employs valve 1 to control the supply of air to reservoirs 1 and 2, valve 2 to vent reservoirs to atmosphere, valve 3 to supply or vent air to tire A, valve 5 to supply or vent air to tire B, valve 4 to equalize pressure between reservoirs 1 and 2. A three axis accelerometer is employed to determine various accelerations, as described in greater detail herein, a Hall Effect sensor is employed to determine the rotation rate and total rotations of an associated wheel-end, total mileage and so on as described in greater detail herein. Signal conditioning circuits filter and amplify signals, including those from tire temperature sensors 1 and 2 and tire pressure sensors 1 and 2.

In accordance with principles of inventive concepts, system 108 may be controlled using electrical/electronic control systems. Such systems may rely on direct or indirect sensor inputs. The control system may integrate assembled raw data input collected over various time frames or create representations of situations resulting from either predetermined predicted events or as developed as a result of analysis or synthesis of data amassed for trend analysis, for example. In example embodiments this enables the diagnosis of the system's current state or the determination or prediction of future states of the system. In example embodiments such predictive assessments are in the form of transient or steady state predictions. These predictive performance processes and data based unit-specific operational projections allow system 108 to determine or execute actions that may result in the overall tire inflation system being maintained in optimal performing condition or provide an accurate forecast of near term operational performance of the tire(s) associated with system 108. In example embodiments, system 108 may communicate the actions performed or the predictive information to a vehicle operator through user interface 916 or communications interface 910 or a vehicle maintenance/logistics manager at fleet server 106 or portable communications device 110, for example.

Controller 906 may include a number of sensor inputs, including any of those identified herein. Inputs to the main controller 906 (for example, Microcontroller (MCU), System-on-Chip (SoC), Field Programmable Gate Array device (FPGA), or a custom Application-Specific Integrated Circuit (ASIC), etc.), which may be used to calculate Diagnostics and Prognostics for the operational performance or forecast communication of the inflation system, may include those indicated as the functionality of a system in accordance with principles of inventive concepts is further disclosed.

In example embodiments controller 906 may actively and continuously monitor (e.g., many times, per second) all sensors when an associated vehicle or system 108 is in motion, and, upon request, when system 108 is not in motion though, perhaps, at lower frequency rates. Power for the system may be from a power generator 900 (also described as 212), which may provide continual power to system 108 whenever the vehicle is in motion. This continual availability of power may allow sustained sampling protocols for sensors and other inputs at a rate much greater than is possible with fixed energy (e.g. non-rechargeable battery) source devices. These higher sampling rates not only provide a greater level of real-time knowledge of what is transpiring within a vehicle system, but may also allow for much greater capabilities as to signal analysis. In example embodiments, such analyses may include Frequency Analysis and Spectral Analysis (such as, but not limited to Fourier Transforms, Gabor Transforms, Power Spectral Density Analysis, etc.) for the sensor data.

The performance of frequency analysis on various sensors within the system in accordance with principles of inventive concepts provides many benefits. For example, by using Fast Fourier Transforms (FFT's), system 108 may detect frequency abnormalities via one or more accelerometers to provide early warning to a driver (or other) of issues with a tire, for example. Through use of Gabor Transforms, a system in accordance with principles of inventive concepts may develop predictive behavior, thereby enabling the use of Artificial Intelligence in example embodiments. These types of analysis may be possible due to the frequency and volume of sensor data collected, for example, into the Megahertz range and over sustained periods of time (in the range of seconds or greater in example embodiments). Such sampling is made possible as a result of power availability, as generated within system 108. The availability of such a continual power source also allows system 108 to transmit data, analytic, diagnostic, and prognostic results over wireless circuitry at full power without the need for power conservation in example embodiments.

In example embodiments, tire air pressure may be monitored over time (1 sensor per tire, or multiple tires per sensor). Additionally, redundant pressure sensing may be employed. In example embodiments redundant pressure sensing methods may include: direct sensing, which may include primary pressure sensor (s) (Digital or Analog), or indirect sensing, which may include wheel speed & temperature monitoring or other methods. Indirect methods may be utilized as stand-alone monitoring methods or as a means of assessing/confirming performance of direct sensing elements. In addition to pressure monitoring, temperature monitoring may also be provided real time or over time to provide an accurate assessment of the pressure/temperature state of the tire or an inflation reservoir in example embodiments. To that end, example embodiments may use direct sensing using a thermistor or thermocouple, with either providing an analog type of output, or possibly, a temperature sensor providing digital output. The collecting of both the state of pressure associated with a given temperature in example embodiments provides a more complete assessment of the state of a tire or reservoir pressure and determination of actions if any necessary to achieve a desired state.

System 108 may monitor wheel RPM over time to yield diagnostic and prognostic results. In example embodiments, collecting data to assess both speed and distance traveled may be performed both directly and indirectly. In an example embodiment a system includes direct sensing of the rotation of the monitoring, analysis and control system 108 primary shaft axis A through the use of Hall Effect sensors or similar methods, providing both number of rotations as well as an associated time per rotation. In example embodiments, power generator signal phases may be used as a redundant or backup check on actual direct sensors, or may be used in lieu of direct sensors. For example, Hall Effect Sensors may be a primary or a direct method of monitoring wheel rotation, to both calculate the wheel rotation speed and for odometer functionality. Use of built in analog to digital capabilities of controller 906 to monitor the phase of the electrical generator, allows monitoring of wheel rotations indirectly, by tracking the altering phases of the generator, for example. The capturing of this information provides both a means of checking Hall Effect sensor performance, with a second method of monitoring wheel rotation and an alternative way to monitor wheel speed, by measuring the frequency of the signal. In example embodiments this provides the ability to closely monitor critical sensor functionality for speedometer and Odometer functions, as well as, general motion of system 108, with both direct and indirect monitoring methods.

Using wheel rotation monitoring in example embodiments may provide a means of determining miles traveled by system 108 or an associated wheel/tire assembly (for example, by multiplying the number of rotations by the outside circumference of an associated tire). In example embodiments this information may be used internal to assess the current status of the system and to forecast future system status. Additionally, in example embodiments such information may be used to advise the vehicle operator of upcoming periodic mileage-based events, such as filter replacement, tire replacement, or simply providing an axle mileage indicator, which an operator may employ to determine whether to replace an axle or other component, for example.

In example embodiments, the controller may monitor multiple sensors, both direct and indirect, to determine performance status, using tiebreaker logic (both real time, and over time), as well as, nearest neighbor data assessment to determine which sensors are performing adequately and which sensors the system should most trust. In example embodiments this logic may apply to speedometer and odometer functions, as well as other system parameters/sensors within system 108.

Example embodiments of system 108 monitor vibrational inputs to the system through the use of 3-axis accelerometer sensors. These vibrations may come from many sources and their analysis allows system 108 to provide added insight into the overall health of the wheel-end to which system 108 is attached. For example, accelerometer inputs, including both frequency and magnitude, may be analyzed for periodic perturbations of the rotating system, and compared to known issue states. Such data, and associated analysis by system 108, may provide early notification capabilities for such things as tire anomalies such as tread wear, incorrect size tire, tire bulges, tire deformations, foreign objects (e.g., nails, screws or other sharp objects), or other damage, for example, developing wheel-end issues, such as worn bearings, wheel-end and road-induced wheel damage such as locked brakes, damage rims, etc., for example. Additionally, in example embodiments, identifying pot-hole strikes and damage associated with the strike may be provided by a system in accordance with principles of inventive concepts. Time stamps by controller 906 of such an event, along with GPS location data for that time stamp (in example embodiments a GPS receiver is included in system 108 or GPS data may be obtained through communication with a separate system on board the vehicle), may provide documentation for the location of damaging road conditions, providing early identification of deteriorating road conditions, facilitating their rapid repair, or possibly providing documentation of vehicle damage.

In example embodiments, battery voltage status may also be monitored using, for example, direct sensing resistor divider input, providing replacement recommendations when levels fall below a prescribed level. Notifications may be made to the vehicle operator or the logistics manager, possibly multiple times; initially as voltage levels fall to a low, but functional level, and subsequently as levels fall to nonfunctional levels. Where such information may not be available, users may be instructed to replace batteries on prescribed time-based intervals, independent of battery status. Additionally smart battery conditioning and monitoring processes may be employed by a system in accordance with principles of inventive concepts.

Similarly, a system 108 filter assembly may be monitored by the controller for filtering performance, indirectly, for example, by monitoring pumping efficiency, or other sensor or filter performance related data. Should such monitored values reach a targeted level, notification may be sent, for example, to the vehicle operator or a logistics manager (through fleet server 106 or portable communications device 110, for example). There may be multiple levels of notification with regard to filter performance, similar to battery replacement, indicating varying levels of filter contamination. Filter assembly replacement, in the absence of this predictive method of filter assessment, may be done through instructions to a maintenance provider to do periodic time-interval based replacement. A filter assembly may additionally be monitored for actual removal from the vehicle through direct methods, such as use of magnetic switching or make-break contact switching, which could detect the removal of the filter assembly from the lower housing of system 108, or possibly indirect sensing based on “burp” rate differences between the new and old filter with the older filter having slower “burp” rates. The monitoring of filter replacement allows the monitoring of number of miles of active pumping, as well as, total miles, which could be used in determining filter replacement requirements.

In example embodiments, other parameters and functions may also be monitored by system 108. The monitoring of such parameters/systems may provide confirmation of proper ongoing performance or may provide indicators of near term performance issues that may warrant attention or possibly security concerns. Examples of such areas that may be monitored in accordance with principles of inventive concepts include: generator assembly (electrical or mechanical) parameters such as voltage over time, or voltage phase lag possibly using resistor divider input; generator assembly temperature over time, possibly using thermistor, thermocouple or digitals temperature sensors may also be monitored or collected; regulated voltage outputs, including 12V DC Buck/Boost Switching Regulator, associated with elements of the system such as valves, etc., and possibly 3.3V DC Buck Switching or LDO Regulator as may relate to electronic circuitry or the like. Control circuit current consumption may also be monitored, possibly with a Low Ohmic Shunt Resistor or similar means as well as possibly magnetic trigger pairing sensor status for security purposes, and wireless signal strength via Relative Received Signal Strength (RSSI) feature possibly on a Transmitter/Receiver.

In example embodiments, the monitoring of these parameters may provide an indication of many factors, including: vehicle running time, miles traveled, energy harvester and associated bearing health, as well as providing the basis for performance actions such as operational health of the electrical generator, operational health of electrical valves, energy harvester perturbation control, generator oscillations, time and speed based notifications and calculations, authorized or unauthorized removal of the monitoring, analysis and control system 108 from the vehicle, external communications status, etc.

In example embodiments controller 906 may also rely on a Real Time Clock (RTC) to help monitor time for functions that may include both diagnostic and prognostic functions, examples of which are described below. In addition to system time, many short-term events may be closely monitored, such as vibrations per second, etc., and, thus, the internal resources of the controller, such as high-speed timers based on the main oscillator will be frequently used for such purposes, allowing for very accurate short timescale, for example, down to the microsecond range.

In example embodiments, controller 906 may actively and continuously monitor the state of the entire system 108. When the vehicle/system pair is in motion, these element states may include, but are not limited to: state of flow related valve assemblies, state of compressor pump assembly, state of the energy harvesting transmission mechanism, state of filter assembly performance, state of battery assembly, pairing state, with/and between systems 108, nearest monitoring, analysis and control system neighbor(s) state. The controller may also monitor the pairing state of a magnetic pairing sensor. The pairing sensor state change related to the position of lower cover magnet and wheel mounting bracket magnet. The removal of a system 108 from the vehicle may cause a state change in the magnetic pairing sensor. In example embodiments, protocols may be included in the controller that may identify authorized state changes versus those that, in the absence of aforementioned protocols, may be deemed as unauthorized state changes. The protocols may include specified wireless signals to the controller or other removal authorization methods. An unauthorized removal may result in system shut-down, a notification sent to designated entities, etc.

Inflation

In example embodiments a system in accordance with principles of inventive concepts may provide compressed air (e.g., for tire inflation) through either a Centralized Tire Inflation System (CTIS), through a Distributed Tire Inflation System (DTIS), or through a combination of CTIS and DTIS systems. Sensors, such as temperature or pressure sensors, located in the manifold area of a wheel-end unit provide tire pressure information for use by a processor in accordance with principles of inventive concepts. In example embodiments a wheel-end unit includes a pressure sensor for each tire. Pressure reading s may be compared to a target value, which may be a default setting, input by the user, or part of a feature application, depending on feature selected (e.g. 1. Use default as shipped from manufacturer; 2. Set a target using an interface set-up such as a phone APP; 3. Select a feature such as load based pressure setting that varies target load based on load projections).

In a CTIS system, compressed air may be stored in one or more compressed air tanks and distributed from the one or more tanks to tires (e.g., tires on a semi-trailer) through a compressed air distribution system. The compressed air distribution system may include a regulator that receives compressed air from a tank and passes it to tubing, which may be flexible tubing, at a set pressure and, through the tubing, to the hollow, non-driven, axles of the semi-trailer. From the hollow axles the compressed air is delivered to a wheel spindle. A rotary coupling mounted at the wheel spindle end then delivers the compressed air to the tire valve. The rotary coupling typically has one end that is stationary and is mounted to the wheel spindle; the other end is attached to a tire valve through a hose extending therebetween.

In a DTIS system, each wheel-end has a wheel-end unit associated with it that includes an onboard compressor, such as the quasi-stationary-, or pendulum-powered, compressor described herein. The compressor supplies compressed air for the one or more tires on a wheel end.

In an example CTIS embodiment, compressed air may be supplied, through a rotary coupling, to a manifold connected to a compressed air reservoir, which, in turn, supplies compressed air to the one or more tires associated with a wheel-end, under control of a wheel-end monitor and control unit in accordance with principles of inventive concepts. The compressed air reservoir may be as described in conjunction with the description of a DTIS wheel-end unit herein. That is, in example embodiments the compressed air reservoir may be the same compressed air reservoir described as receiving compressed air supplied by operation of a wheel-end compressor, or pump, such as a quasi-stationary compressor system described herein.

All the functions: monitoring, control, analysis, etc., provided by the controller of a wheel-end unit as described herein in conjunction with a DTIS system may be available to a wheel end unit supplied with compressed air through a central distribution system. Electrical power generated by a pendulum generator, as described herein, may also be provided in a wheel-end system in CTIS example embodiments.

In example embodiments compressed air from both a central distribution system (i.e., tank, regulator, rotary coupling, etc.) and from a wheel-end compressor (e.g., a pendulum compressor as described herein) may be supplied to a manifold and, from there, to a compressed air reservoir such as a reservoir described herein.

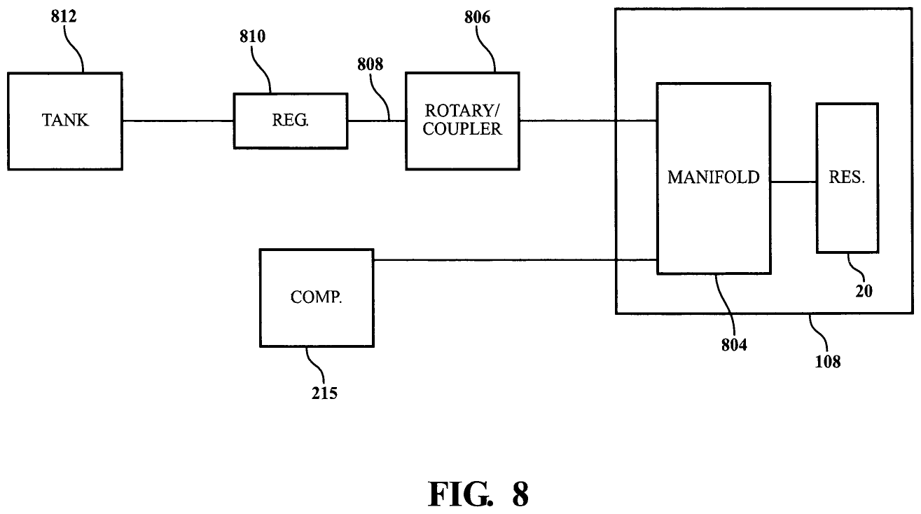

The block diagram of FIG. 8 illustrates tire inflation components of example embodiments of a flexible vehicle monitor and control system in accordance with principles of inventive concepts. The system may be configured to operate, along with other optional features, as a CTIS, DTIS or hybrid combinatorial CTIS/DTIS vehicle system. Wheel-end unit 108 may be as otherwise describe herein, with manifold 804 supplying compressed air to reservoir 20 and, under control of a controller as described in greater detail herein, supplied to vehicle tires from reservoir 20. Manifold 804 may be configured to accept input from rotary coupler 806, which, in turn, is supplied compressed air from tank 812 via regulator 810 and tubing 808. Manifold 804 may be also be configured to receive compressed air from wheel-end compressor 215. In example embodiments manifold 804 may be configured to receive compressed air from rotary coupler 806 (in a CTIS embodiment), from wheel-end compressor 215 (in a DTIS embodiment), or from both a rotary coupler 806 and wheel-end compressor 215 (in a CTIS/DTIS combinatorial embodiment). In any of the embodiments, the wheel-end system may provide the monitoring and control functions described in greater detail elsewhere herein. In example embodiments centrally-supplied (e.g., tank) and locally supplied (e.g., wheel-end compressor) compressed air may be introduced to a wheel end in a variety of ways, including, for example, by having manifold ports for both an external tank and for a wheel-end compressor or by supplying compressed air from an external tank and/or from a wheel-end compressor through a segmented air intake, for example. The tank air may be replenished, when needed, by air supplied from the hub mounted wheel-end compressor through the manifold assembly.

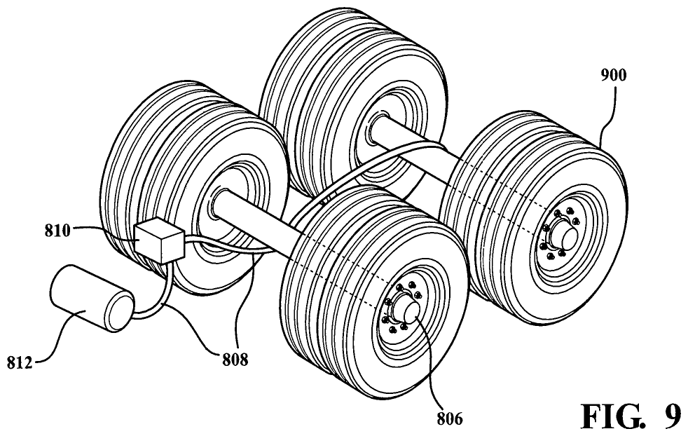

The schematic diagram of FIG. 9 illustrates a group of eight wheels 900 with associated tires, such as may be found on the rear of a semi-trailer. Rotary coupler 806, compressed air tank 812, regulator 810 and tubing 808 are as described in the discussion related to FIG. 8. Wheel-end units in accordance with principles of inventive concepts (not shown in this view) may be mounted to wheel-ends of wheels 900 as previously described.

An entire fleet of vehicles may already have CTIS systems installed and, to limit expense, the fleet may be retrofitted with wheel-end units in accordance with principles of inventive concepts in order to provide the monitoring and control functions described herein, while taking advantage of the existing compressed air system. In example embodiments, the system may be implemented as a CTIS system, a system that includes the wheel-end system monitor and control functions, a purely DTIS system, such as has been previously described, or a combinatorial system, which provides monitoring and control, along with compressed air supplied by a compressed air tank (CTIS) and supplied by a wheel-end compressor (DTIS). In example embodiments, the wheel-end compressor units can be used to individually or collectively recharge the central tank. The availability of a substantial supply of compressed air in a tank provides for rapid air exhaust and rapid air refill. This may be desirable, for example, in off-road or other applications where a larger tire footprint may be desirable and rapid transition between higher- and lower-inflation levels is advantageous.

In example embodiments a system in accordance with principles of inventive concepts with central and/or distributed (e.g., with wheel-end compressors) compressed air supply may employ one or more compressed air tanks that may be maintained at a higher pressure than the pressure required by the vehicle tires and that, with monitor and control in accordance with principles of inventive concepts, may provide instantaneous compressed air flow to a targeted tire. In addition to allowing for rapid inflation/deflation, a combinatorial CTIS/DTIS embodiment may allow a vehicle with a leaking tire to stay on the road for a longer period of time than a vehicle with no onboard or DTIS only compression. That is, in the event that a tire leak is substantial and that it overwhelms the capacity of a wheel-end compressor, additional compressed air may be provided by a CTIS' larger capacity one or more storage tanks under control of a monitor/control system in accordance with principles of inventive concepts. In example embodiments, one compressed air subsystem (e.g., a wheel-end compressor) may be employed primarily to maintain tire pressure during quotidian operation, while another compressed air subsystem (e.g., one employing compressed air tank(s)) may be devoted primarily to rapid inflation/deflation to adjust to load conditions or to road conditions. Varying load conditions may be accommodated by providing higher pressure for heavier loads or lower pressure for lighter loads. Varying road conditions may be accommodated by providing higher pressure for on-road travel or lower pressure for larger footprint, off-road operation that may benefit ATVs, farm equipment, or construction equipment, for example. Although one subsystem may be substantially dedicated to one or the other function, both systems may be used in concert for maintenance and for rapid adjustment of tire pressure. Monitor and control functions described herein may be provided in accordance with principles of inventive concepts to systems with or without onboard (e.g., wheel-end) compression and may be employed to maintain constant tire pressure, to adjust tire pressure to accommodate varying load or road conditions, and to maintain or adjust at a tire- or axle-specific granularity.

Odometer Speedometer Accelerometer

In example embodiments a wheel-end unit may provide odometer, speedometer, or accelerometer functions and those functions may be employed, for example, to analyze wheel alignment, brake drag or wheel bearing issues for a vehicle associated with the wheel-end unit. By comparing the number of revolutions per mile of one axle against another, wheel alignment, brake drag, or bearing issues may be uncovered. For example, if all the tires on a vehicle were of substantially the same dimension (the same size, the same inflation, etc.), they should rotate the same number of times for a given distance. In example embodiments a wheel-end unit implements a speedometer or odometer and one or more wheel end units, or a central processor, compares the odometer readings from a plurality of wheel-ends units to determine the status of wheel-alignment, brake drag, or bearing condition, for example.

In example embodiments odometer and speedometer functions may be implemented using a direct measurement approach that employs a sensor specifically to detect the rotation of a tire, or by using an indirect measurement approach that uses an artifact of a wheel-end electrical generator or an artifact of a wheel-end accelerometer, for example.

In example embodiments, a direct measurement approach may employ a sensor such as a Hall effect sensor or a photocell, for example, in combination with a light source or magnet, respectively. In a Hall effect sensor example embodiment, the Hall effect sensor may be positioned on a rotating portion of a wheel-end unit to interact with a magnet positioned on a non-rotating element of the wheel-end unit, such as a quasi-stationary element used in the production of electrical energy or compressed air, as described herein. In a photocell example embodiment, a photocell may be positioned on a rotating portion of a wheel-end unit to detect light from a passing position on a quasi-stationary element of the wheel end unit. The detected light may be produced by a light source co-located with the photocell and reflected back from a position on the quasi-stationary element or the light source may be positioned on the quasi-stationary element. With the sensor (e.g., Hall effect sensor or photocell) sensing the passage of the active element (magnet or light source), a processor may determine the number of rotations of an associated tire in a given period of time. From that, given the circumference of the associated tire (which may correspond to a tire size and inflation level and entered or downloaded by an operator) the processor may determine the distance travelled during that period (an odometer function), the average speed (speedometer function), or the change in speed (acceleration function) of an associated vehicle during that period.

In example embodiments an accelerometer located on a rotating portion of a wheel end unit may be used to determine the number of times a wheel has rotated and, as described above, from the number of rotations, distance, speed, and vehicle acceleration may all be determined by a wheel-end unit in accordance with principles of inventive concepts. An accelerometer located on a rotating portion of a wheel end unit may be used for a variety of analyses, but, in particular, may be used to detect the rotation of a tire by analysis of one or more characteristics of the accelerometer signal, correlating the characteristic to a wheel rotation. For example, one cycle, or multiple cycles, of signal variations from the accelerometer may correspond to one rotation. By monitoring accelerometer signals, a processor may determine the number of rotations an associated wheel has undergone, and, from that, vehicle distance, speed, and acceleration may be determined as described above.

Similarly, in example embodiments an electrical generator located on a rotating portion of a wheel end unit may be used to determine the number of times a wheel has rotated and, as described above, from the number of rotations, distance, speed, and vehicle acceleration may all be determined by a wheel-end unit in accordance with principles of inventive concepts. An electrical generator may be employed to provide power to electronic components of a wheel-end unit, as described elsewhere herein, and may be used to detect the rotation of a tire by analysis of one or more characteristics of the accelerometer signal, correlating the characteristic to a wheel rotation. For example, one cycle, or multiple cycles, of signal variations (for example, peaks of a sin wave) from the accelerometer may correspond to one rotation. By monitoring the generator output, a processor may determine the number of rotations an associated wheel has undergone, and, from that, distance, speed, and acceleration may be determined as described above.

In example embodiments any of the above-described approaches to determining distance travelled, speed, or acceleration may be used alone or in any combination. In some embodiments results from a plurality of methods may be combined in various manners, such as averaging, may be checked against one another in a voting process (for example, eliminating a result that does not agree with two or more other results), or may be used to detect a failure among the various components related to such determinations (for example, if a reading from a sensor is in significant disagreement, the sensor may be defective).

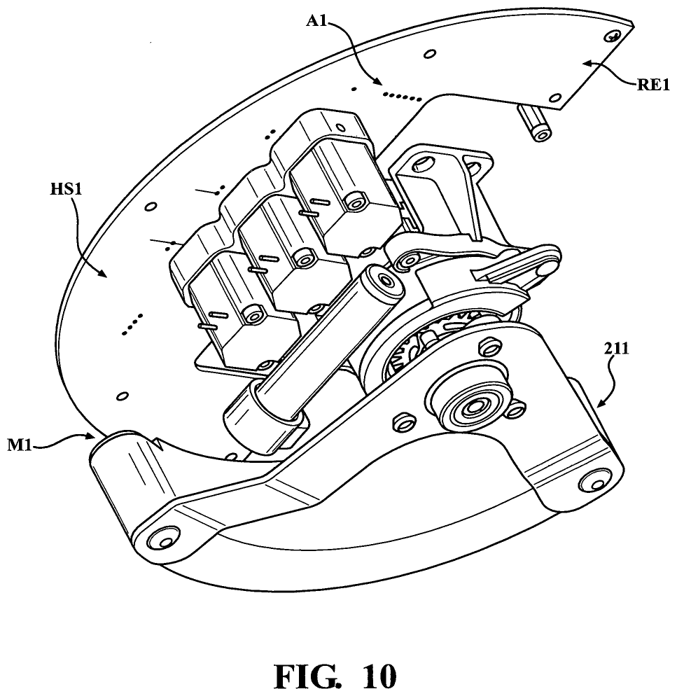

The perspective view of FIG. 10 illustrates an example arrangement of a Hall sensor HS1 located on a rotating element RE1 and a magnet M1 located on a non-rotating, quasi-stationary, element 211 of a wheel end unit 108 in accordance with principles of inventive concepts. Hall sensor HS1 and magnet M1 are positions so that Hall sensor HS1 will detect and respond to the magnetic field of magnet M1 each time the rotating element RE1 rotates the Hall sensor HS1 past the magnet M1 as an associated wheel rotates. Accelerometer A1 may be positioned as illustrated on rotating element RE1.

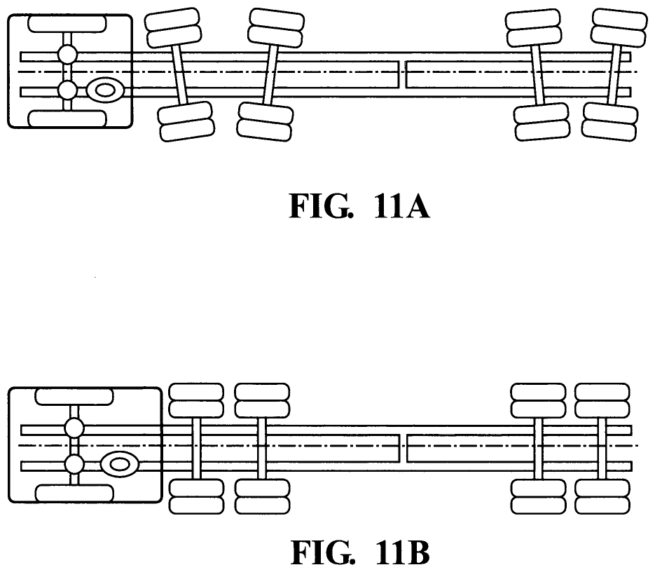

As previously indicated, in example embodiments, distance, speed, or acceleration of a wheel-end may be employed to assess axle alignment, brake drag, or wheel bearing status. Ideally, a vehicle's axles are aligned perpendicular to the vehicle's direction of travel; they are in perfect “alignment.” Axles that are “out of alignment” (that is, do are not aligned perpendicular to the vehicle's direction of travel) can negatively affect the performance of the vehicle by increasing tire wear, negatively impacting the quality of the vehicle's ride, or even contributing to accidents. FIGS. 11a and 11b illustrate out-of-alignment and in-alignment axles on a five-axle vehicle, respectively.

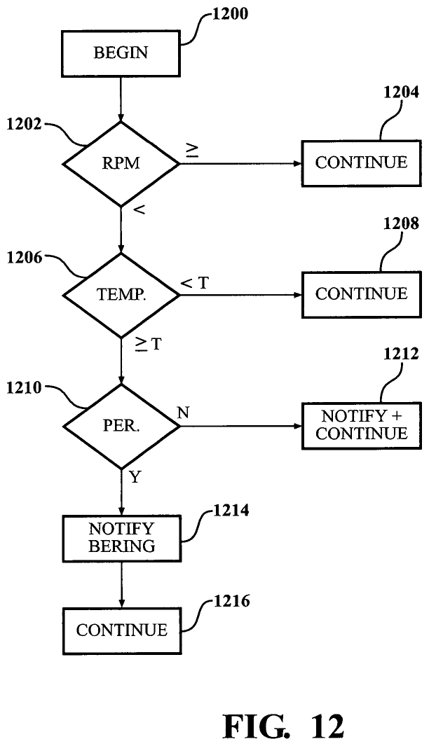

If an axle is out of alignment, tires on the axle will scrub for a portion of the travel proportional to the degree of misalignment. In example embodiments, one or more wheel-end units or a hub compares the number of rotations per mile associated with different axles and, from that comparison, determines whether or not one or more axles is out of alignment and, if so, provides an indication of the severity of the misalignment. In example embodiments, among the issues of misalignment, brake drag, or wheel bearing failure, misalignment may be assumed to be the most likely cause of a low rotation count and may be the first fault examined in an example process as described in the discussion related to FIG. 12.

In example embodiments a system and method in accordance with principle of inventive concepts may compare the rotation of axles, adjacent axles on the same vehicle, for example, to detect any rotational difference. If the axles and wheel-ends traversing the same terrain, with the same size tires and same inflation (that is, all the tires have the same circumference), they should all rotate the same number of times for a given distance if they are free-rolling (that is, if there is no impediment to their rolling). In example embodiments, the system may determine that, if the number of rotations is different, axle to axle or wheel end to wheel end, there may be some “scuffing”, or slipping on the tires associated with axles and wheel-ends that are rotating less. Such scuffing may be the case for a solid non-driven trailer axle, or for an “open” non-locked differential drive axle. For these axle types, the system concludes that there is “scuffing” associated with the slower (lower rotations) tire/axle set.

As noted above, the scuffing could be associated with various vehicle elements, depending on degree of rotation difference e.g. brake drag, axle alignment, bearing defects, etc. Brake drag may also manifest itself with an elevated temperature on the axle end or wheel end associated with the dragging brake. Temperatures increases may be exacerbated as the rotational differences between axles become larger. In example embodiments, both temperature and rotations could be used to determine the increasing severity of scuffing and drag. Alerts could be sent advising the driver or logistics manager at preset targets; targets possibly being specific values or increasing rates, for example. Driven “open carrier” axles without limited slip differentials will exhibit a difference of rotation across a given axle while lock differentials may exhibit similar rotations across axle. Similar methods would apply to assessing open axles as with locked axles, recognizing the rotational differences can provide added identifiers. In example embodiments an axle end with the lower number of rotations may be identified as a likely location of the dragging brake.

Turning now to FIG. 12, the process beings in step 1200 and proceeds from there to step 1202, where an axle's number of rotations or rate of rotation is compared to that of one or more other axles on the vehicle. If the number of rotations, or rate of rotation, is greater than or equal to the rate of other axle(s), the axle is deemed to be in alignment and, other than a positive status indication, no further action may executed by the wheel end unit and the process proceeds to step 1204, where it may terminate or return to step 1200. As with all assessments in this process, a range of values may be employed in this determination. For example, a threshold value below “equal” may be assigned in the determination of whether an axle requires attention or not. An assessment such as this may be repeated continuously.

If, on the other hand, the number or rate of rotations is less than that of one or more other axles in step 1202, the process proceeds to step 1206 where a temperature measurement from a thermal sensor associated with a wheel-end unit of a slower-rotating tire is compared to a threshold value and, if less than the threshold value, the process proceeds to step 1208, with a conclusion that the axle is misaligned and an indication of such misalignment may be stored or transmitted to the vehicle's driver, maintenance personnel, or management/dispatch personnel. A higher temperature may indicate a greater degree of misalignment and, in example embodiments, a system in accordance with principles of inventive concepts may diagnose the degree of misalignment and make recommendations (for example, to realign the axles sooner if the misalignment is greater), based upon the degree of misalignment. Axle misalignment would result in tire scrub, elevating the temperature/pressure within the associated tire, and, in example embodiments, a system includes temperature and pressure sensors on the air supply of each tire and can, therefore, measure the temperature and pressure of each tire. Brake drag would tend to increase the temperature of the hub structure. A system in accordance with principles of inventive concepts may compare the temperature of tire air to the temperature of an associated hub to distinguish the effects of misalignment from the effects of brake drag. In example embodiments, tire air temperature change may be employed to detect misalignment and structure temperature (for example wheel-end temperature) may be employed to detect brake drag. If, in step 1206, it is determined that the temperature is greater than a threshold value, the process proceeds to step 1210, where accelerometer signals are examined. If signals from the accelerometer are aperiodic beyond a threshold level, indicating that the tire stops or slows considerably at random times, the process proceeds to step 1212 with a conclusion that the brakes are dragging and a notification may be stored or transmitted, as with a misalignment assessment. If, in step 1210 the accelerometer signal exhibits periodic behavior the process proceeds to step 1214, with a conclusion of a wheel bearing issue and a notification may be stored or transmitted, as with misalignment or brake drag assessments. From step 1214, the process may proceed to step 1216, where the process continues. In example embodiments, notifications may be assigned higher or lower priority, based on the severity of the malfunction (the level of temperature elevation, for example), the history of measurements, or other factors.

Balancing

In example embodiments a system and method in accordance with principles of inventive concepts may employ one or more accelerometers to sense accelerations associated with a wheel, axle, or hub to which the wheel end unit is attached or otherwise in mechanical communication with. For clarity of description we may employ the term “wheel” herein in reference to any or all of: a wheel, an axle, or a hub. In example embodiment a multi-axis accelerometer, a triaxial accelerometer for example, may be employed. A processor may employ accelerometer readings to determine whether a wheel is out of balance and, if so, the location and mass suitable for a balancing weight that may be applied to bring the wheel into dynamic balance. In example embodiments dynamic balance may be continuously monitored and stored or forwarded for use by maintenance personnel, a driver, a supervisor, or a fleet manager, for example. With the information available in this manner wheels may be balanced on a regular basis, resulting in smoother rides, reduced cargo vibration, and improvements in tire longevity, for example.

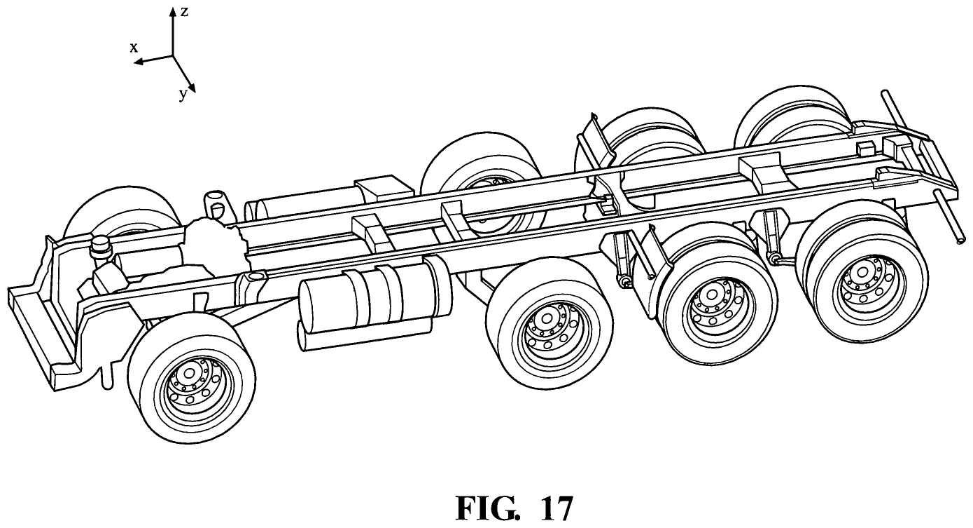

In example embodiments a wheel-end unit in accordance with principles of inventive concepts may employ wheel rotational speed and wheel acceleration values to determine whether a wheel is out of dynamic balance and where, and how much, weight may be added to the wheel to bring it into dynamic balance. A wheel-end unit may rely primarily upon acceleration signals from two axes, the two that form a plane that is perpendicular to the travel surface and that nominally bisects the wheel (shown as “X” and “Z” axes in FIG. 17). In example embodiments, a processor may employ the speed and acceleration values to determine a wheel-end amplitude and, comparing the wheel-end amplitude to a threshold value or threshold range, may determine that a wheel end is out of balance and, if so, to what degree, with the degree corresponding to how far the amplitude is beyond the threshold value, for example.

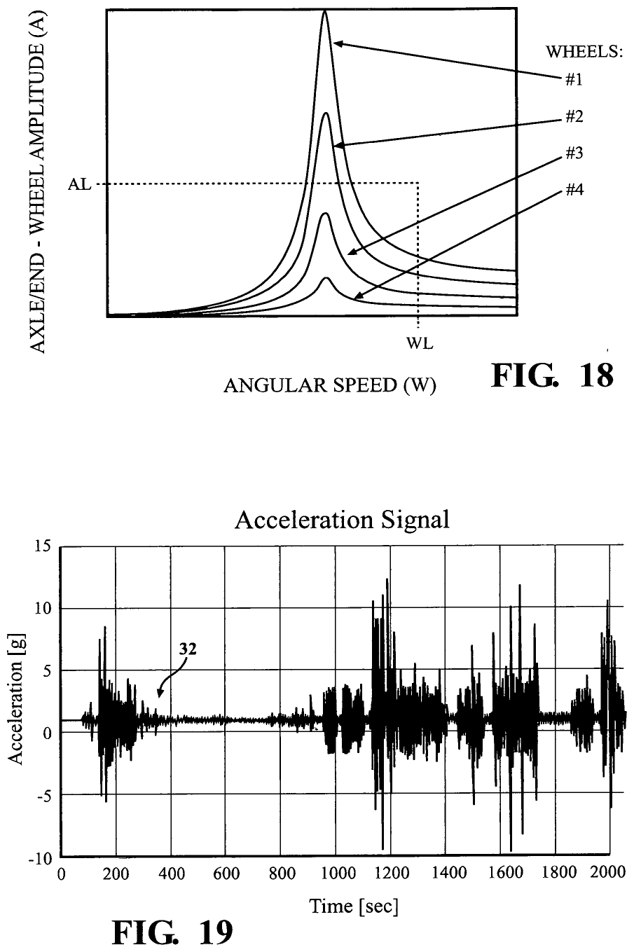

In example embodiments, the frequency analysis is carried out over a range of wheel speeds that, at a minimum, reaches the resonant frequency ωL of the wheel/tire and hub. As illustrated in the example of FIG. 18 wheels 1 and 2 exceed the wheel amplitude threshold AL and, as a result, a system in accordance with principles of inventive concepts provides an indication, stored or transmitted, that the relevant wheels are out of balance. A similar process may be carried out using acceleration data, by thresholding acceleration values, rather than wheel amplitude values. An example plot of acceleration versus time, illustrating the variance of wheel acceleration over time, is given in FIG. 19. The plots are intended for illustrative purposes, to afford a user a visualization, and may be presented to a user, such as an operator or maintenance manager.

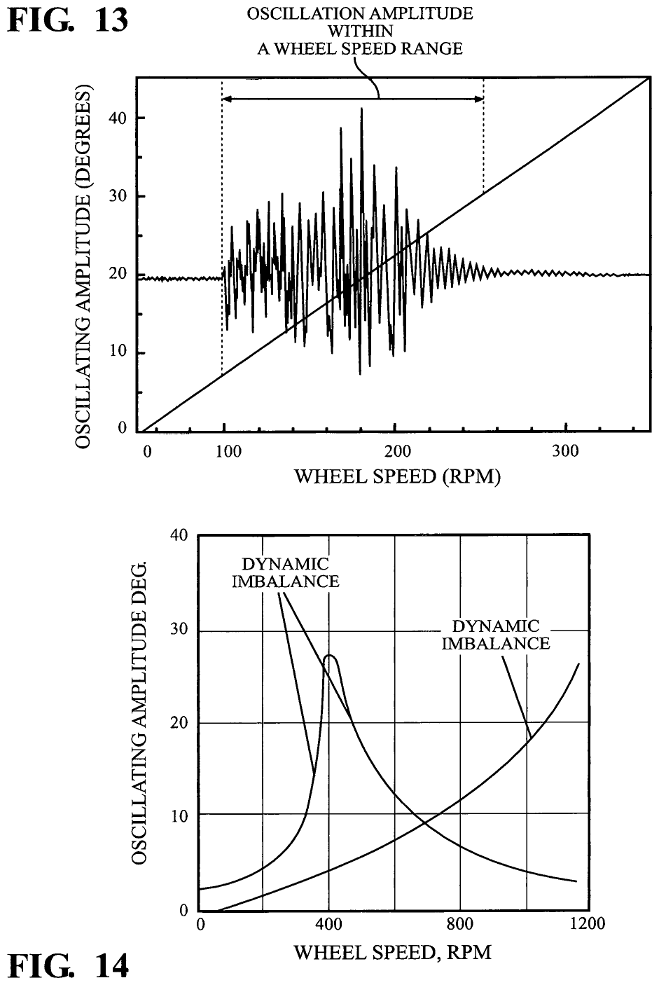

In example embodiments, a wheel-end unit is installed in the wheel hub of a vehicle axle. A triaxial accelerometer, or a series of vibration transducers and speed sensors, may be used to sense the out-of-balance accelerating forces caused by an imbalance of the wheel assembly. The “X” and “Z” accelerometers may be used to sense the out-of-balance accelerating forces caused by the magnitude of imbalance of the wheel assembly; a speed sensor may be used to sense the angular velocity and angular location of such imbalance. In the case of dynamic imbalance, the magnitude of wheel twitching increases to a maximum and then decreases with further increase of wheel speed. This is illustrated in the graphical illustration of FIG. 13, which plots wheel speed vs oscillating amplitude vs vehicle speed.

A dynamic unbalanced wheel can be driven on road without noticing any appreciable instability at speeds that fall on either side of the critical period of oscillation (maximum amplitude). However, if the wheel is driven within the narrow critical speed range, violent wheel wobble results. Any looseness in the swivel pins or steering linkage ball joints with unbalanced tires promotes excessive wheel twitch or wobble, causing not only the steering wheel vibrations, but also heavy tire tread scrub and wear, as illustrated in the graphical representation of FIG. 14, where wheel speed is plotted vs oscillating amplitude.

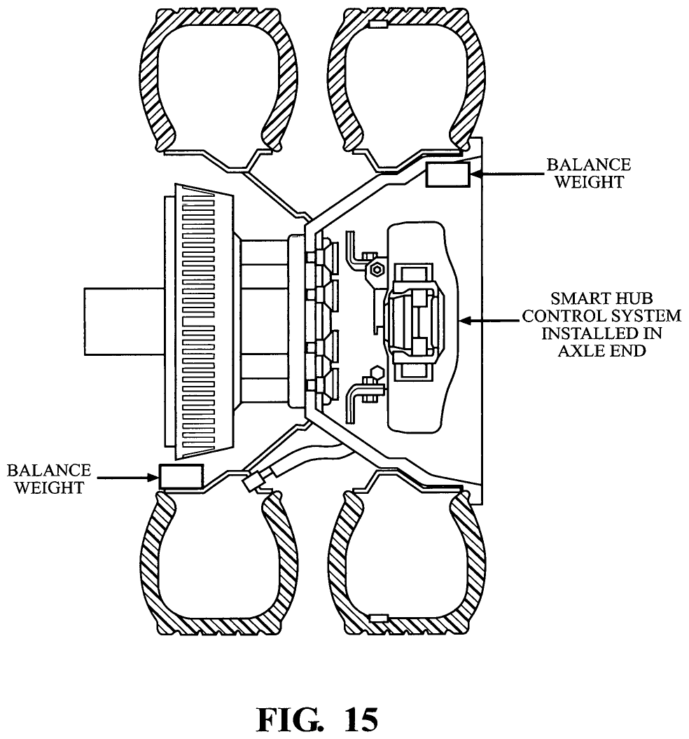

In example embodiments, the output signals from the “X” and “Z” accelerometers and the speed sensor are fed into a compensating network of the wheel balancing feature and are processed by a processor, for example, in wheel-end unit. The output signals are filtered to eliminate unwanted frequency components, amplified and further processed. The outputs from the compensating network are proportional to the required balance weights in the left- and right-hand balancing planes of the wheel or wheels respectively of a given hub assembly, as illustrated in the example embodiment of FIG. 15. The speed sensor converts a sinusoidal voltage into a sharply defined pulse, which occurs at the same predetermined point in every cycle. This sharply defined pulse is a measure of the relative phase position of the voltage, which indicates the position of the required balance weight in the rim. In this manner a wheel balancing feature of in accordance with principles of inventive concepts may measures and provides correction for both static and dynamic imbalance of the wheel end with respect to both the outer and inner wheel/tire rotating planes by, for example, comparing them to a library of data of tire diameters, rim sizes, balancing weights, angular position of the weights and wheel speed ranges.

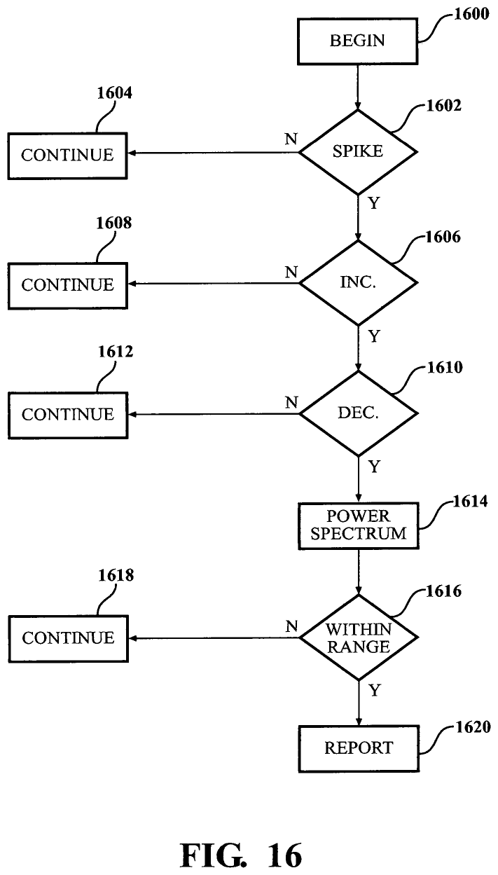

An example embodiment of wheel balancing process in accordance with principles of inventive concepts is illustrated in the flow chart of FIG. 16, which begins in step 1600 and proceeds to step 1602, where the system determines whether a periodic acceleration spike appears over the vehicle speed range. If there is no spike over the speed range the process proceeds to step 1604 and continues monitoring. If, in step 1602, the system determines that a periodic acceleration spike has been detected, the process proceeds to step 1606, where the system determines whether the acceleration spike increases with increasing vehicle speed. If the acceleration spike does not increase in amplitude, the process proceeds to step 1608, and continues monitoring. If, in step 1606, it is determined that the acceleration spike is increasing, the process proceeds to step 1610, where it is determined whether the acceleration spike is decreasing with continued increasing vehicle speed.

If it is determined in step 1610 that the acceleration spike is not decreasing with increasing vehicle speed, the process proceeds to step 1612, and continues monitoring. If it is determined in step 1610 that the accelerations spike is decreasing with increasing vehicle speed, the process proceeds to step 1614, where the signals are amplified, converted to the digital domain, and then converted to the power spectrum. From step 1614, the process proceeds to step 1616, where it is determined whether the amplitude variation increases and decreases within a given vehicle speed range. If it does not, the process proceeds to step 1618, and continues monitoring. If, on the other hand, the system determines that the acceleration amplitude variation increases and decreases within a given vehicle speed range, the process proceeds to step 1620, where the system reports the imbalance weight amount and location for. This information may be stored for future reporting, so that maintenance personnel may apply balancing weight(s) at a scheduled time or may be transmitted to a driver, maintenance personnel, or fleet management personnel, for example.

Wheel Separation

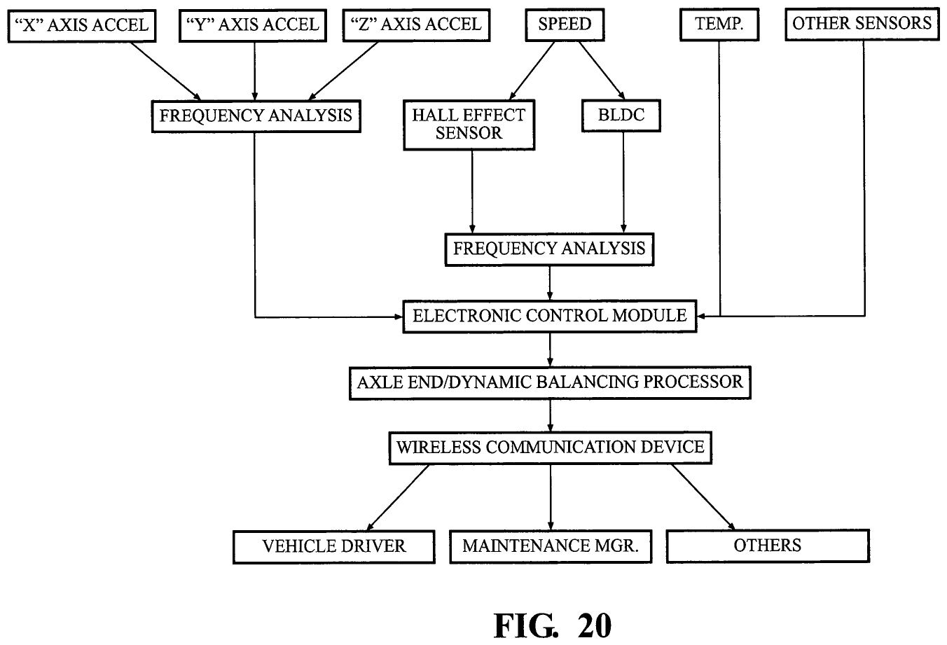

The block diagram of FIG. 20 provides an overview of an example embodiment of a process for detecting potential wheel separation in each wheel end of a vehicle through a wheel-end unit 108 in accordance with principles of inventive concepts. In each vehicle wheel end, there is a wheel-end unit 108 installed. A plurality of different sensors are installed in each wheel-end unit 108 (for example, X, Y, and Z axis accelerometers, speed, temperature and other sensors), with which driving state variables, including the wheel speeds, vehicle accelerations, wheel end temperature, system voltage, etc. and a plurality of other features may be detected.

The signals from the “X” and “Z” acceleration sensors are employed as different individual inputs signals for the avoidance of wheel separation. Feature within each wheel end unit 108 evaluate and process the “X” and “Z” acceleration sensors inputs in the Wheel End/Dynamic Balancing Feature for the detection of individual wheel potential separation. The main sensors aimed at providing the key data for processing are the triaxial acceleration sensor, speed sensor and temperature sensor. The rate of change in the “X” and “Z” accelerometer evaluated imbalance is significantly different from the data experienced with typical wheel/tire separation imbalance data. This is detected by erratic spikes in the “X” and “Z” accelerometers, with increasing magnitude. In example embodiments, autocorrelation or crosscorrelation may be made with the triaxial accelerometers from the opposite wheel hub to confirm the condition. This condition may also be detected by variations in speed (via a speed sensor) and temperature (via a temperature sensor) in the wheel hub. These data inputs are assessed by a processor, such as a processor within wheel-end 108, and evaluated for the type of condition being assessed. If the evaluation and assessment reveals that there is a potential wheel separation, a warning signal may be generated in the appropriate communication device and may be displayed in the vehicle, in particular in an acoustic, optical or haptic manner, or be transmitted wirelessly to the driver, fleet maintenance manager and any other desired recipients.

Acceleration and angular rotation and perturbations of a tire may be measured and analyzed over time by a controller that may be located in a wheel end assembly to determine whether a wheel/tire is undergoing incipient structural changes that could lead to a wheel/tire separation or other structural flaws such as loose bolts. A continuous acceleration and angular rotational signal data stream may be employed by the controller for analysis and, should a structural condition of concern be detected, an alert may be provided to a user, such as a driver, a dispatcher, or maintenance personnel. The controller may employ pattern recognition, for example, for analyzing the measured acceleration and angular motion of the wheel/tire and determining the structural health of the wheel/tire. The controller may employ any of a number of machine learning processes and devices, including, but not limited to: a convolutional neural network, an artificial neural network, a Hopfield network, Baysesian networks, a Markov Chain Monte-Carlo method, for example, trained to determine whether the tire is experiencing tread separation (or other telltale signs) based on sensor measurements, such as acceleration, angular rotation, temperature, and pressure fluctuations associated with the wheel/tire, as determined over a period of time. A library of classifiers may be developed and trained on data obtained from sensors that may be employed to identify specific wheel/types of failure (for example, specific types of separation, increasing bolt loosening, etc.), as well as the degree to which the failure has progressed.

As previously noted, sensors may include: accelerometers, pressure sensors, temperature sensors, video (visible, ultraviolet, or infrared, for example) sensors, or audio sensors, for example. In order to reduce power requirements, a sensor (located, for example, on a wheel-end) may derive power from an electromagnetic query signal by inverting the signal in the manner of a passive RFID tag and may communicate with an off wheel-end processor through an RF link, for example. A sensor may transmit data directly to, or, in a distributed processing embodiment, through a wheel-end located processor, to an off wheel-end processor for data reduction and analysis.

A wheel/tire roadworthiness, monitoring system may monitor, analyze, store, report or provide alerts for wheel/tire conditions, such as delamination or other tire conditions, that may reduce efficiency, impose hazards, or otherwise be of concern to a vehicle operator, owner or to the general public. An optical sensor (also referred to herein as a camera, which may be a still or video camera and which may operate in the visual, infrared, or ultraviolet range, for example) may be located off the wheel-end and may be powered by the vehicle voltage bus, for example. The optical sensor may be used to monitor a wheel/tire and, in conjunction with a processor and machine learning, may be trained to detect wheel/tire separation and may relay images of the wheel/tire to a system, either on or off the vehicle, for further analysis and prediction, for example. Some types of wheel/tire failure may manifest themselves in the form of wobbling movement or other abnormal wheel/tire profiles and these may be detected optically. Optical systems may be mounted to view a wheel/tire's rims and/or sidewalls in order to detect anomalies and to assess the wheel/tire-to-ground relationship and tire contact patch.

As may be seen in the block diagram of FIG. 20, a control module (which may include an axle-end/dynamic balancing processor function) within wheel-end unit 108 may employ frequency or other analysis on sensor inputs to continually assess wheel security at each hub, to employ time interval accelerometer analysis, to compare data across hubs and to compare data from various time intervals to develop a rate of change in readings and analyses.

Axle Bearing Status

In example embodiments a wheel end system in accordance with principles of inventive concepts one or more accelerometers sense vibrations associated, for example, with a wheel, axle, or tire to which the wheel-end unit is coupled (for example, by attachment to the wheel-end). The accelerometer(s) may be multi-axis accelerometers, such as three-axis accelerometers, for example. Vibrations in the form of accelerometer signals may be analyzed by a processor, such as a processor within a wheel-end unit, to determine whether the signals may evidence rotational anomalies, such as a degradation or failure of a wheel-end component, such as a wheel bearing, for example. Because a wheel-end unit in accordance with principles of inventive concepts is coupled to a vehicle wheel-end, it may collect and analyze accelerometer data as the associated vehicle is in motion, during regular operation, for example. In example embodiments a system and method in accordance with principles of inventive concepts may convert the accelerometer signals for analysis in the frequency domain. Frequency domain analysis may allow the system to distinguish vibration signals from different sources and from different manifestations from those same sources, for example.

Although some bearing analysis systems may be available they do not have a power source or generator and, as they are mounted on the outboard side of a wheel rim, they are difficult to mount and are susceptible to damage when a wheel is mounted or dismounted. Such systems are typically tailored to detect bearing vibration signatures only in the time domain; a wheel end unit in accordance with principles of inventive concepts may provide analysis in both time and frequency domains. By generating power onboard, a system in accordance with principles of inventive concepts may operate at a sampling frequency unavailable to a conventional system, as they are power-limited. Additionally, a system in accordance with principles of inventive concepts provides a processor and and related computing capabilities to detect, compute and analyze all related vibration signatures from the wheel/tire/hub assembly such as tire delamination, wheel/tire imbalance, etc., In example embodiments, a wheel-end unit 108 may provide several performance advantages, such as being able to assess the beginnings of anomalies and comparing the observed readings with those on the other axle ends. Also, a wheel-end unit in accordance with principles of inventive concepts can not only assess and analyze various vibration signatures and provide feedback to the users, but it is also capable of monitoring wheel end assembly speed, temperature, pressures and it is also capable to set predetermined thresholds for these various parameters in accordance to specific application requirements. Some advantages of being located on a wheel-end in example embodiments include:

Providing a distributed, independent system.

Providing the ability to monitor individual wheel-end assembly performance and able to correlate information from different wheel-end assemblies within the same axle or different axles.

Providing better protection from the environment.

Providing the capability of monitoring the complete wheel-end assembly performance behavior characteristics.

Providing the ability to be programmed for specific needs.

Providing easy and immediate communication with external sources.

Providing the ability to be easily installed and removed from a vehicle (being attached to through wheel-end lug bolts)

Providing the ability to be removed from one unit (tractor and/or trailer) and be installed in minutes on to another tractor and/or trailer.

Providing the ability to be installed or removed without requiring a trained technician.

In example embodiments a wheel end unit may can monitor, analyze, and project future performance based upon vibrations sensed by one or more accelerometer(s) associated with a wheel end unit. The wheel end-unit may analyze accelerometer signals (which may be represented, for example, as rotational acceleration curves of the hub) to detect periodic variations in the signals, to identify their sources, and to characterize their impact.

The vibrations may be represented as perturbations imbedded into the sinusoidal of the rotational accelerations of the tire/wheel rotation. In example embodiments the signature of the perturbations may be assessed by transforming from a time/frequency domain to a frequency/frequency domain. Once rotational anomalies are detected, a determination of type and severity of an anomaly may be further assessed. In example embodiments a library of machine learning tools, such as a library of classifiers, may be developed for use with a wheel-end unit for detection, analysis, and prediction of wheel bearing faults. In example embodiments a machine learning protocol may employ such degradation state performance lii has been loaded into a library allowing an assessment and prediction of degradation type and degree or severity. The hub/axle may experience elevated temperatures and in later (more severe) instances rotational issues. Alerts could be sent visually and/or audibly advising the driver and logistics manager at preset targets; targets possibly being specific values as well as increasing rates.

In example embodiments the analysis performed by the diagnostic may employ both the frequency and the time domain. Each of type of analysis may be used to address a particular type of signature. If two events occur simultaneously but contain different frequency components, a system and method in accordance with principles of inventive concepts may separate them, conceptually, in the frequency plane. In example embodiments, if there is a small signal buried in random noise or if two events with the same frequency content occur separately in time, they may be more readily detected by time averaging. A triaxial accelerometer or other vibration sensor in a system in accordance with principles of inventive concepts generates an electrical signal representative of the mechanical and acoustic vibrations of wheel/end.

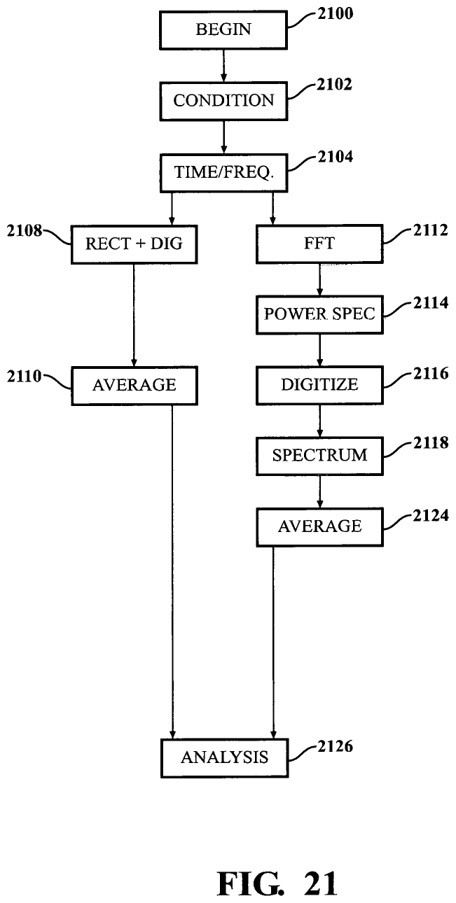

The flow chart of FIG. 21 illustrates an example process flow in accordance with principles of inventive concepts. The process begins in step 2100 and proceeds from there to step 2102, where one or more sensor signal(s), such as accelerometer signals, are presented to signal conditioning circuitry, which amplifies and filters the signals before splitting in step 2104 for time- and frequency-analyses.

For the time analysis, in example embodiments, the signal is rectified then digitized (step 2108) before being averaged in step 2110. For the frequency analysis, in example embodiments, a Fast Fourier Transform may be performed (step 2112), and the power spectrum analyzed in step 2114. The power spectra may be generated at high computing speed (for example, vibration and speed signals computed at 2750 HZ). The FFT output may be in the form of an analog voltage that represents the equivalent signal, in the bandwidth. In example embodiments this output voltage may be digitized (step 2116) and separate spectra are then computed for equal fractions of a revolution, such as 1/16 of a revolution (step 2118). This, in example embodiments, prevents loud noises produced by other components' actions from masking defects that occur during other wheel-end angle positions. In step 2124 both time and frequency signals are averaged multiple times to improve the signal-to-noise ratio. A position reference signal may be generated regularly, once per revolution for example, by a device such as a sensor that senses the hub rotation. The position reference signal is employed in example embodiments to synchronize the averaging of the data so that the analysis is always started at the same angular position of the hub. In step 2126, in example embodiments, a wheel-end unit analyzes the preprocessed data and inspects the results. The analysis may employ methods described in greater detail elsewhere herein.

These results may be transmitted wirelessly to the various operational units for appropriate disposition. Additionally, the system may monitor wheel-end temperature and cross reference temperatures of wheel-ends on the same axle and also with separate axles. Temperature may be used to predict life of the bearings, because it directly affects the preload conditions of the bearings.

In example embodiments, one or more triaxial accelerometers, temperature sensors, velocity and other sensors may be used in conjunction with any one or any combination of: vibration amplitude versus time domain analysis, fast fourier transform versus frequency domain analysis, envelope vibration analysis, or spectral emitted energy analysis, to identify wheel bearing anomalies and alert an operator or other personnel to the type of anomaly and its implications regarding potential failures and recommended maintenance or replacement.

In example embodiments a wheel-end system may employ one or more triaxial accelerometers to detect anomalies in vibrations signals and, from anomalies, diagnose potential degradation or failure of a wheel bearing. This may all be done as the vehicle associated with the wheel bearing is in motion, during normal operation. The system may assess thermal performance on a wheel hub associated with a wheel-end unit and across vehicle wheel hubs to develop a baseline and potential change rate. This information may be used to rule out other possible sources of anomalies, such as brake drag, tire tread separation, delamination or other sources. A system may compare the change rate to vehicle wheel end specific thermal rate signatures. In example embodiments, this provides continuous assessment of the potential incipient condition but also it can predict the time interval for repair or replacement of the bearings. High temperature and vibrations are the main causes of bearing failures and both parameters are continuously monitored and when, in example embodiments, pre-set thresholds are reached; the system will send alarms to the user.

In example embodiments, a system may compare vibrations in different axes to assess correlation and repeatability of data for a given hub. In example embodiments, a system may examine vibrations in the longitudinal axis direction (that is, “along” the direction of the axle) to assess proper end-play. Assessments may be done and compared to a baseline signature or confirmed with an axle to axle assessment. Tight bearings could result in increased friction, resulting in differing rotational performance or excess looseness may exhibit a Y axis vibration (in the longitudinal axle direction) periodicity. A system and method in accordance with principles of inventive concepts determines whether end-play is outside a preferred range (too great or too little) and provides a diagnosis and prescription for corrective action if end-play is out of range.

In example embodiments, notifications, to a driver or other personnel, may be via text-message, or other electronic communications method. Hub-based signatures may be evaluated with adjacent- and cross-axle acceleration data to evaluate for road induced noise and compare axle to axle and wheel end to wheel end performance. By monitoring and analyzing wheel bearing vibration and thermal signals a system in accordance with principles of inventive concepts may detect bearing degradations or failures well before they can cause an unplanned stop and prevent breakdowns, thereby avoiding expensive repairs. In example embodiments, a system's warning system reduces the threat of a wheel-off, which increases driver safety. Close monitoring and analysis while the vehicle is in motion, that is, while the vehicle is operating, allows the bearing to be replaced when it reaches the end of its life, avoiding unnecessary maintenance. In example embodiments, a wheel end system may be retrofitted to existing wheel-ends, consequently, no change over is required

Rolling contact bearings represent a complex vibration system whose components (ie rolling elements, inner raceway, outer raceway and cage) interact to generate complex vibration signatures. Bearing vibrations may have a variety of sources including, for example: variable compliance, geometrical imperfections, surface roughness, waviness, raceway defects, rolling element defects, cage defects, discrete defects or other sources of vibration. Although the fundamental frequencies generated by rolling bearings may be described by a relatively simple computation, they cover a wide frequency range and can interact to yield very complex signals. A discrete defect on the inner raceway of a bearing will generate a series of high-energy pulses at a rate equal to the ball pass frequency relative to the inner raceway. A discrete defect on the outer raceway will generate a series of high energy pulses at a rate equal to the ball pass frequency relative to the outer ring. Defects on the rolling elements can generate a frequency at twice the ball spin frequency and harmonics and the fundamental train frequency. Cage defects do not typically excite specific ringing frequencies and this limits the effectiveness of analyzing the envelope spectrum, as the signature is likely to have random bursts of vibration. Other sources of vibration may include contamination, which is a common source of bearing deterioration. These characteristics are used by a system in accordance with principles of inventive concepts to detect anomalies and identify their sources, using amplitude/time, FFT/frequency, or other analyses, including using machine learning techniques that may include the development of libraries of vibration signatures, such as libraries of vibration signature classifiers, for use in comparing measured values to values that are emblematic of defects.

Wheel end vibration may exhibit low frequency pulsation that is independent of accelerometer position and that is road speed dependent. Wheel end vibration may be caused by radial and lateral tire runout, sidewall stiffness, wheel component balance, excessive wheel bearing clearance, frame beaming, trailer/tire interaction, worn shock absorbers, or brake drum and rotor run out, for example.

In example embodiments, vibration measurement can be generally characterized as falling into one of three categories: detection, diagnosis and prognosis.

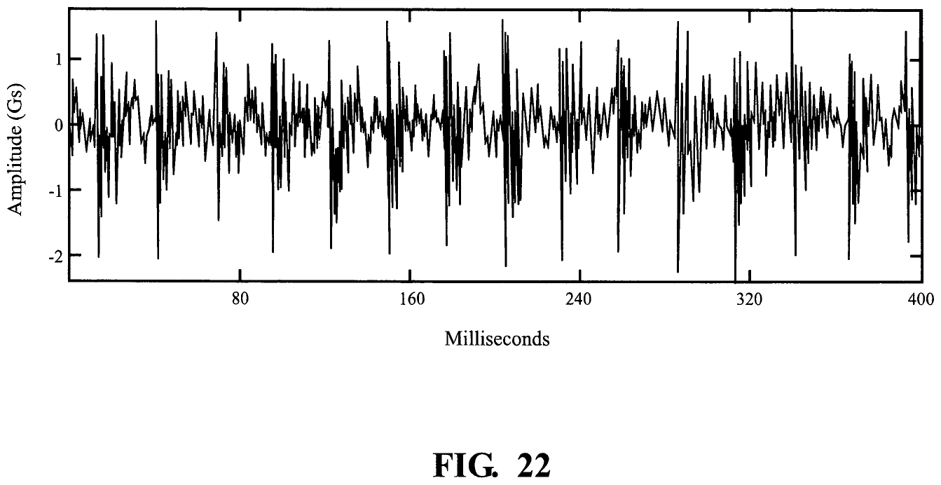

Detection may use a form of vibration measurement, where the overall vibration level is measured on a broadband basis in a range, for example, 10-1,000 Hz or 10-10,000 Hz. In machines where there is little vibration other than from the bearings, the spikiness of the vibration signal indicated by the Crest Factor (peak/RMS) may imply incipient defects, whereas the high energy level given by the RMS level may indicate severe defects. This type of measurement gives limited information but can be useful in example embodiments when used for trending, where an increasing vibration level is an indicator of a deteriorating machine condition. Trend analysis involves tracking the vibration level as a function of time, as illustrated in FIG. 22 and using the trend to predict when the vehicle should be taken out of service for repair. Another way of using the measurement is to compare the levels with previously developed vibration criteria for different types of equipment or vehicles.

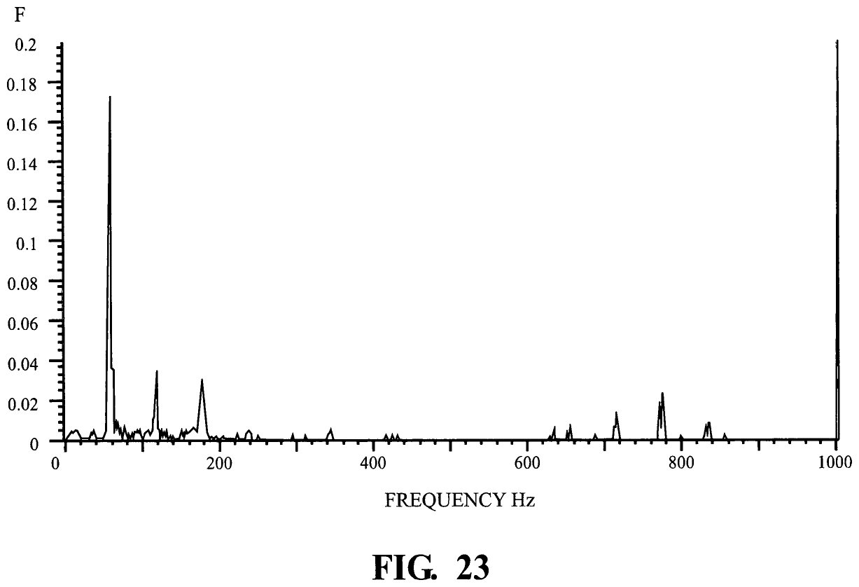

Although broadband vibration measurement may provide a good starting point for fault detection it has limited diagnostic capability and, although a fault may be identified, it may not give a reliable indication of where the fault is (for example, whether bearing deterioration/damage, unbalance, misalignment etc). For an improved diagnostic capability, in example embodiments, frequency analysis may be used. Such analysis may give a much earlier indication of the development of a fault and also the source of the fault, as further described in the discussion related to FIG. 23.

Having detected and diagnosed a fault, the prognosis (for example, what the remaining useful life and possible failure mode of the wheel, bearing or other vehicle component) in example embodiments, a wheel-end unit may rely upon the continued monitoring of the fault to determine a suitable time for the vehicle to be taken out of service. In example embodiments a wheel end system may also, or alternatively, call upon existing data from other similar events (for example, a wheel bearing with this frequency spectrum has failed within a known range of operational miles in the past).

In example embodiments, a wheel end unit may employ overall vibration level measurements by measuring the Root Mean Square (RMS) vibration of the bearing housing (hub) or some other location on the wheel-end or axle with the transducer located as close to the bearing as possible (for example, with a multi-axis accelerometer located within a wheel-end unit). In example embodiments, the system measures the vibration over a wide frequency range, such as 10-1,000 Hz or 10-10,000 Hz. The measurements may be trended over time and compared with known levels of vibration and corresponding fault levels. Pre-alarm and alarm levels may be set to indicate a change in the vehicle's condition. Alternatively, or additionally, measurements can be compared with general standards.

In example embodiments, frequency analysis may play an important part in the detection and diagnosis of vehicle faults. In the time domain the individual contributions (eg unbalance, gears etc) to the overall hub vibration are difficult to identify. In the frequency domain they may be more readily identifiable and a wheel end system may relate a particular frequency component to a source of vibration on the vehicle. For example, a fault developing in a bearing may appear as increasing vibration at a characteristic frequency. Using frequency analysis a wheel end system may detect and identify the source of anomalous vibration at an earlier stage than with an analysis of overall vibration. The plot of FIG. 23 provides an illustration of the manner in which frequency components may be separated.

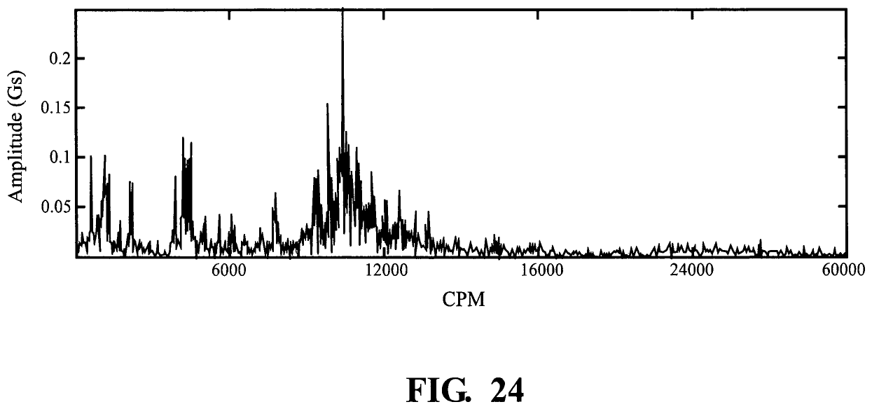

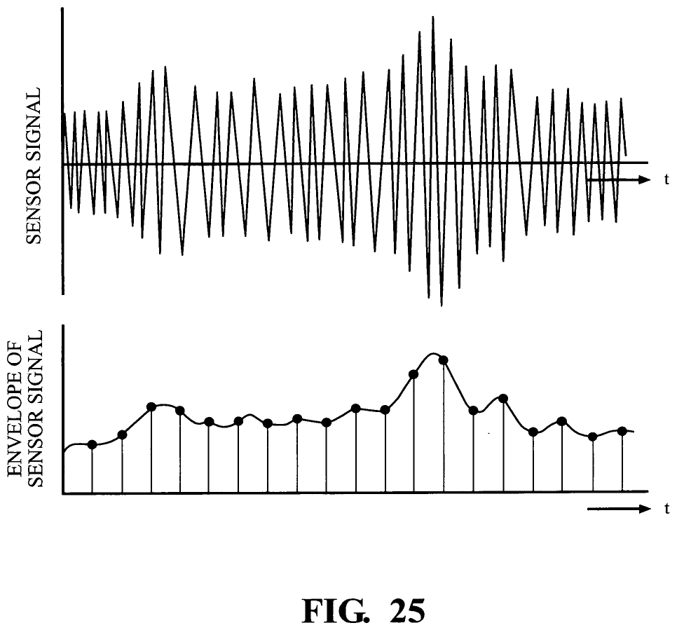

When a bearing starts to deteriorate, the resulting time signal often exhibits characteristic features, which, in example embodiments, may be used to detect a fault. Also, bearing condition can rapidly progress from a very small defect to complete failure in a relatively short period of time; so early detection requires sensitivity to very small changes in the vibration signature. The vibration signal from the early stage of a defective bearing may be masked by axle/tire noise, making it difficult to detect the fault by spectrum analysis alone. In example embodiments envelope analysis may be employed to provide early stage detection of bearing faults. One advantage of envelope analysis is its ability to extract the periodic impacts and the modulated random noise from a deteriorating rolling bearing. This is even possible when the signal from the rolling bearing is relatively low in energy and ‘buried’ within other vibration from the axle/wheels. A graphical representation of envelope analysis is illustrated in FIGS. 24 and 25. Envelope detection filters out low frequency rotational signals and enhances the bearing's repetitive impact type signals to focus on repetitive events in the bearing defect frequency range (for example, repetitive bearing and gear-tooth vibration signals).

In example embodiments, Spectral Emitted Energy (SEE) analysis may provide very early bearing and gear mesh fault detection by measuring acoustic emissions generated by metal as it fails or that is generated by other specific conditions. Circumstances that can cause acoustic emissions include: Bearing Defects, Contaminated Lubrication, Lack of Lubrication, Dynamic Overloading, Micro-sliding/fretting, Bearing Friction, Cavitation/Flow, Electrically Generated Signals, Metal Cutting, or Compressor Rotor Contact, for example. Because, in example embodiments, SEE measures the ultrasonic noise (acoustic emissions) created when metal degrades, a system in accordance with principles of inventive concepts may employ it to detect bearing problems in their earliest stages, when the defect is subsurface or microscopic and not causing any measurable vibration signal.

High Frequency Detection Spectrum (HFD) analysis may be employed in example embodiments to provide early warnings of bearing problems. The High Frequency Detection (HFD) processing method generates a numerical overall value for high frequency vibration generated by small flaws occurring within a high frequency band pass (5 kHz to 60 kHz) The HFD measurement may be performed as either a peak or RMS overall value.

In example embodiments, sensor resonant analysis, similar to HFD analysis, may use the sensor's resonant frequency to amplify events in the bearing defect range. Such an analysis may enhance the repetitive components of a bearing's defect signals and allow a wheel end unit to report its condition at an early stage.

In example embodiments a wheel-end unit in accordance with principles of inventive concepts may include one or more accelerometers, such as multi-axis accelerometers, to generate data related to a wheel-end's acceleration. In example embodiments a processor may employ the acceleration data to determine whether a tire associated with a wheel (e.g., mounted on the wheel) is experiencing tire layer separation or delamination. In example embodiments a system, taking into account the rotational speed of the tire (e.g., in RPM) determines whether the tire exhibits a periodic variation in acceleration. The periodic variation in acceleration may be indicative of a tire separation or delamination event.

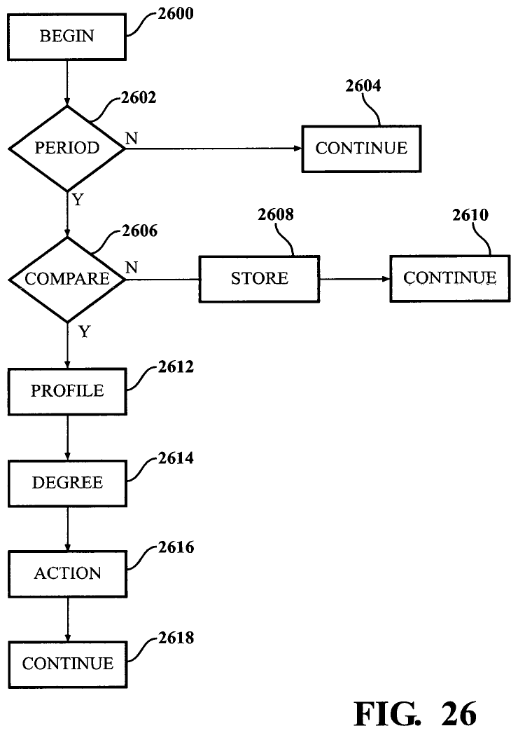

The flow chart of FIG. 26 illustrates and example approach to tire tread separation and delamination detection in accordance with principles of inventive concepts. The process begins in step 2600 and proceeds from there to step 2602, where the system determines whether there is a periodic variation, such as a spike, in acceleration values for a wheel to which the wheel-end unit is coupled. If the acceleration data exhibits no periodic variation, the process proceeds to step 2604, where it returns to continue monitoring the acceleration data. On the other hand, if a periodic variation in acceleration data is detected in step 2602, the process proceeds to step 2606, where a comparison is made to other, adjacent or cross-hub, wheel-end acceleration values to determine whether the periodic acceleration profile is unique to the wheel associated with the processor or the periodic acceleration is shared by other wheels. In the process of comparison, the time/amplitude accelerometer signals may be converted to discrete time signals, then to frequency domain signals, then to power spectra of amplitudes at different frequencies, for example. Comparisons may then be made on the basis of power spectra amplitudes. If the periodic acceleration is shared by other wheels, for example, if a wheel end at the opposite end of the same axle has the same periodic acceleration, the system may ascribe the periodic variation to a source other than tire separation or delamination. For example, if the same periodic variation in acceleration is found in adjacent or in cross-axle wheels, the variation may be due to environmental factors such as evenly spaced bumps in the road surface that may result from disturbances in expansion joints or a washboard surface generated by overuse of the surface. If the system ascribes the periodic acceleration variations to factors other than tire delamination or tread separation it proceeds to step 2610, where it continues to monitor acceleration data. In example embodiments, the process may proceed to step 2608 before step 2610. In step 2608 the system may store or report information related to a road surface that generates periodic acceleration anomalies. If, in step 2606 the process determines that the periodic acceleration anomalies are unique to the hub under examination, the process proceeds to step 2612 the acceleration profile of the wheel under examination is compared to a library of profiles that represent different degrees of tread separation and delamination for a tires such as that under examination. In example embodiments, such a library may be developed for a system in accordance with principles of inventive concepts and may include profiles for a variety of tires and for a variety of degrees of tread separation. A system in accordance with principles of inventive concepts may train and employ one or more classifiers to use in conjunction with machine-learning embodiments. From step 2612, the process proceeds to step 2614, where the type and degree of tread separation or delamination is identified. In step 2616, the process may execute a notification or a corrective action. Notification may include an immediate alert to a driver, a supervisor, a dispatcher, or to maintenance personnel, for example, if the degree of tread separation is beyond a threshold level. Notification may also involve storing tread separation/delamination data and analyses for routine reports at service times, particularly, if the tread separation is below a threshold level that indicates the threat of tire failure is less imminent (for example, that there is less than a 1% chance that the tire will fail during the remainder of the driver's current trip). In example embodiments, corrective actions may also be undertaken. For example, the tire pressures on a set of dual tires may be reset, to shift more load to a “good” tire (one that is not exhibiting tire separation or other symptoms of failure). The tire may be monitored more closely, on a more frequent basis, to determine whether the tire is further deteriorating and, if so, how rapidly, and, if too rapidly, an alarm may be sent to the driver, or others, to have the driver pullover and stop. Tire pressures may be increased or decreased and, by tracking changes in tire parameters, the rate of deterioration (e.g., in the form of pressure loss) may be addressed at a compensating rate (e.g, tire pressure may be increased more rapidly). From Step 2616, the process may continue to monitor in step 2618.

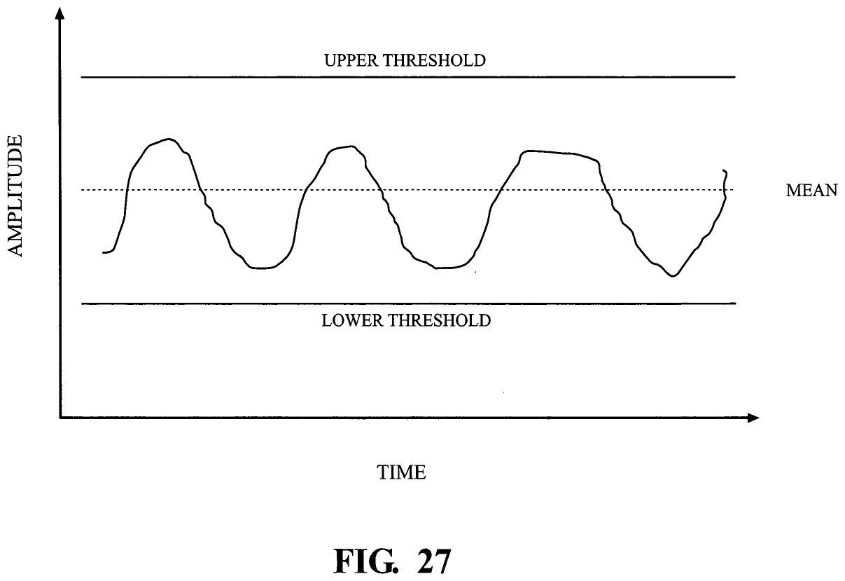

As illustrated in the graph of FIG. 27, in example embodiments, thresholds for “out of bounds” amplitudes may be set above and below a mean threshold value.

During a tread separation at highway speeds, tire to ground contact is reduced as a result of wheel-hop and, on live axles, axle tramp. For partial tread separation events, the steer gradient change due to wheel hop and axle tramp is greatest when axle tramp oscillations are near peak amplitude. The steer gradient change is a transient phenomenon of variable magnitude for complete tire tread separation events. A distinct skipping tire mark may be observed on the roadway from a tire experiencing a tread separation as a result of wheel hop, tire asymmetries and tread slap. A skipping tire mark may also be observed on the side opposite the tread separating tire when axle tramp occurs. Hop or tramp induced roadway markings may be indicative of their occurrence, but the absence of roadway marking should not be interpreted to mean that hop or tramp did not occur.

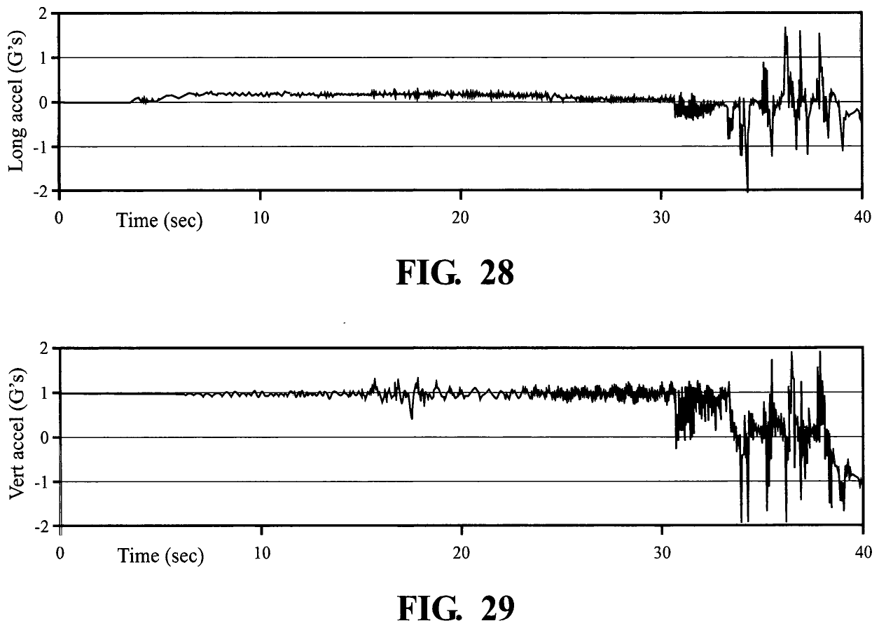

Acceleration forces on the wheel during a tire delamination are vertical and longitudinal in nature as shown in FIG. 28 and FIG. 29. The longitudinal forces will be generated from the retardation of the rotation caused by impacts of the tire flap with the fender and other body parts while rotating resulting in wheel braking. The effects on the retardation of the vehicle cannot exceed the coefficient of friction of the tire interface with the pavement. That interface will most often be the steel belt on the carcass from the tire and the pavement.

The cyclic vertical component of forces is generated due to the imbalance of the tire caused as sections of the tire tread are releasing. The tread flap and remaining tread cause significant imbalance in the tire and are experiencing 250 G's while turning at highway speeds. The magnitude of the vertical force will be affected by the weight of the attached tread and its radius from the axle, the weight of the detaching flap and the radius of the center of gravity of the flap from the center of rotation, and the rotational speed of the wheel/hub system.

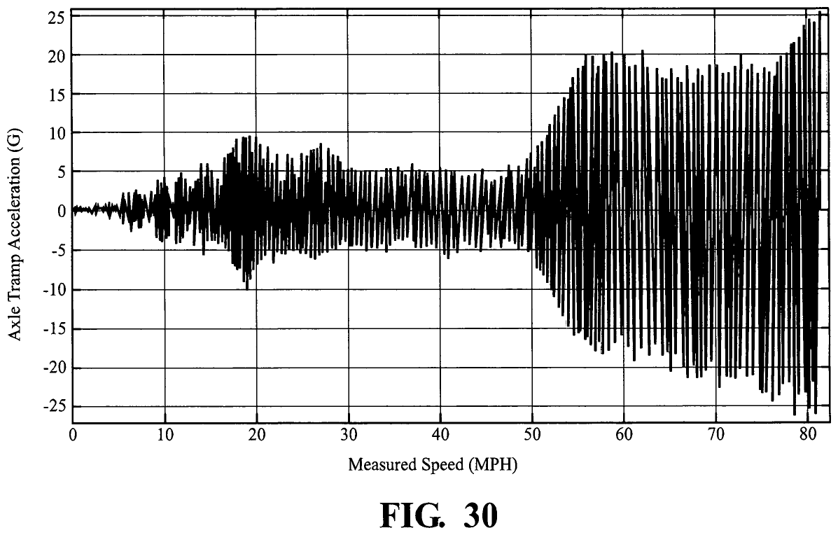

The response of the axle from a single tread section encompassing ½ of the tire causes a sudden growth in response as the harmonic frequency of the axle/tire-spring system are approached. However, instead of the response decreasing after the area of harmonic frequency is passed as the speed increases to 112 KPH (70 MPH), the response shows a slight decrease then continues to grow FIG. 30.

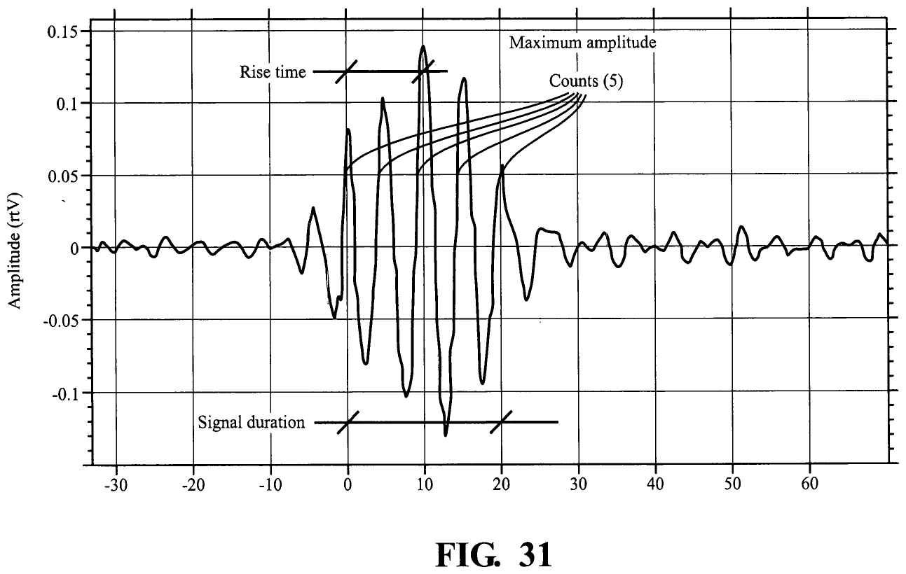

This would be due to the increase in force from the dynamic imbalance increasing as a square of the velocity of the tire. As the high side of the harmonic frequency band is reached FIG. 31, the tire force has grown sufficiently to continue to drive the tramp motion of the axle. Thus for an under damped axle system cyclic tramping motion will continue beyond the band associated with the harmonic frequency, 10 to 15 hertz.

In example embodiments a system performs continual assessment of wheel/tire security (for example, monitors the state of a tire for separation or delamination) at each of a vehicle's hubs. The system may use time interval accelerometer analysis of multiple sensors (X, Y, and Z directtions) to assess a hub's vibration performance; compare data across hubs to assess potential differences; compare data from various time intervals for rate of change data and projection or forecasting degradation; monitor tire pressure conditions and data across multiple vehicle tires; increase or decrease tire pressure according to minimum or maximum thresholds, respectively; monitor wheel end temperature and data across a vehicle's wheel ends; and alert a vehicle driver or fleet logistics manager via text message or other electronic communication that a tire delamination or separation event may be imminent.

Driver Performance

Assessment of driver performance is multi factorial and in example embodiments, may be focused on a variety of parameter types, such as: cargo protection, vehicle longevity, smooth operation, etc. In example embodiments, methods may use any of a variety of the same sensing elements but may provide differing weighting factors to determine the preferred driving behavior.

In example embodiments, accelerometers are used to assess the starting and stopping parameters with accelerations and decelerations being evaluated; primarily “X” direction assessment. Control during deceleration can also be assessed by the assessment of the “Y” direction for things such as jack-knifing potential. “Z” direction accelerations along with vehicle speed may provide an indicator of potential cargo damage. Driving over curbs, railroad tracks, rough terrain may be assessed and reported. Hub rotation, RPM's, would be assessed for deceleration and braking performance, including the possibility of wheel-end “lock-up”. Comparing the performance of the driven vs. the trailered hubs would indicate the driver “presence” associated with the cargo portion of the rig. All such assessments may be made, stored, and reported on a driver-by-driver basis.

Drive Induced Cargo Damage

In example embodiments, accelerometer data may determine “X”, “Y”, & “Z” direction acceleration spikes and any above predetermined maximums will be recorded with value, location, and time of occurrence. If damage claims are made associated with shipped cargo, these records may be used to confirm or deny the conveying vehicle's culpability with the associated claimed damage.

Adjustable Tire Pressure

In example embodiments, tire pressure sensors allow the flexibility for the controller setting of tire pressure targets across a wide range of values. The targets can be set manually, through an application, or can be set automatically by allowing the control systems to adjust a target pressure based on a multiple number of tire/vehicle optimizing parameters applied to a set of optimizing processes. The flexibility in the adjustment of tire pressure targets can result in the applicability of the unit to a much greater range of tires/vehicles as target pressures can be set at pressures associated with tires of any size and/or performance range. This adjustment allows flexibility of use on a given vehicle, as well as, flexibility of the a system in accordance with principles of inventive concept's application for a variety of vehicle types. For example, a wheel-end unit's “set target” may be set to a passenger vehicle type tire target of 35 PSI with tire load of say 1090 lbs. for a P185/6015C C tire. Alternatively, the unit target pressure could be set to a target of 100 PSI for a Semi-Truck with a P275/80R24.5 G tire and related tire load of say 5835 lbs. The proper pressure setting may be adjusted according to the specific tire application and the associated tire loading.

Traditionally, the tire pressure target for automatic tire inflations systems (ATIS) on Semi-Truck trailers has been set by using a spring and/or other type of mechanical control that is preset at the factory for a single type application and setting, or, in other cases, is set in a remote pressure regulating unit on the truck trailer through an arduous and lengthy setting procedure. The vehicle must be stationary during the setting procedure and, consequently, is out of service. In example embodiments a system in accordance with principles of inventive concepts allows the setting of targets independent of vehicle state, e.g. moving or stationary. This approach, employing electronic control, also allows the tire pressure target to be used as a system variable for the optimization of vehicle performance parameters. For example, tire pressure targets are typically set at a single value (e.g. 100 psi) for a semi-truck trailer independent of vehicle load (i.e. empty trucks and fully loaded trucks can vary by 30,000 pounds, but will have the same 100 psi target). This conventional approach is a disadvantageous compromise based on the lack of control and monitoring that, in contrast, a system and method in accordance with principles of inventive concepts may provide. In example embodiments methods may be used to assess the existing vehicle state (load, road conditions, etc.) and adjust the tire pressure to provide an optimal state for varying conditions. For example, if the vehicle is empty a lower pressure would be appropriate, whereas a fully loaded vehicle would benefit from a higher pressure within the tire.

Load Based Tire Inflation

In example embodiments, a system may control tire pressure in a novel manner to adjust to load, vehicle, or environmental factors/conditions. That is, in example embodiments, a system may, in addition to maintaining tire inflation at a desired, targeted, level during vehicle operation, the system may adjust a target inflation level (and inflate a tire to a new target level), according to environmental conditions, vehicular conditions, load conditions, or other conditions. Values associated with such conditions may be determined by the system, onboard a vehicle, or may be downloaded to the system (for example, wirelessly, through a phone app, through a central dispatching and maintenance system, through a travel service system, etc.), for example. Road conditions may include whether the vehicle is on-road or off-road, whether a road is paved, dirt or gravel, or road traction (for example, whether or to what degree, it is slippery). Environmental conditions may include ambient temperature, humidity, or wind speed, for example. Vehicular conditions may include factors cataloged in the vehicle's maintenance history, accident history, or other vehicle-specific information. Load conditions may include the type, weight, or balance of a load, for example.

In example embodiments a system may begin operation with a preset target inflation level, which may be a nominal, factory-recommended level, for example. During the course of operation, the system may continually monitor load, road, environmental or vehicle conditions and adjust target inflation levels according to such conditions and inflate or deflate tires according to the adjusted target inflation levels. In example embodiments, all target inflation levels fall within a safe operating range, as determined by tire manufacturers, safety standards, or experiment, for example.

In example embodiments an optimal tire diameter or, equivalently, by another measure, a “tire contact patch” for a given tire may be selected, for example, from a pressure/temperature table. In example embodiments a system may itself determine load conditions and adjust a target inflation level accordingly by analyzing the number of rotations of a tire for a given distance and comparing that number to the number of rotations of other tires on a vehicle, for example, or, possibly, by using an alternative means, such as a GPS. That is, in example embodiments, the number of rotations may be used to provide an assessment of load within a vehicle and a calculated optimal tire pressure may be determined to provide an optimal tire contact patch. Because, as a vehicle's load increases, the vehicle's tire contact patch would also tend to increase (for a given pressure); this could result in a diminished performance. In example embodiments, tire pressures could be adjusted to maintain a desired tire contact patch, with adjustments to pressure performed iteratively and results checked by the system against tire rotation data updates until a target level is reached.

In greater detail, a tire with a set pressure and set load, F1, will have a rotating radius, or, equivalently, circumference, L1. If the load is increased to load, F2, the rotating radius will tend to decrease, from L1 to L2 because the air pressure acts in the manner of a spring. In example embodiments a system in accordance with principles of inventive concepts may monitor the number of wheel rotations for a given distance or time and compare the number of rotations for different tires in order to determine an measure of the load a tire is subjected to. For example, if three tires on the passenger side of a truck average 506 rotations per mile over a ten mile stretch of road but a fourth tire, on the rear of the driver's side, for example, averages only 502 rotations. If, additionally, all four tires are nominally dimensioned to rotate 506 times per mile, the tire averaging only 502 miles may be scuffing along the pavement surface. In example embodiments a system in accordance with principles of inventive concepts, may operate in a “dynamic pressure setting” mode, whereby, upon detecting the discrepancy in rotations, it may respond as though the lower-rotation tire were being subjected to a heavier load and, consequently, increase the tire pressure supplied to that tire. By increasing the tire pressure, the tire contact patch would be adjusted for more efficient operation. In example embodiments, the system may adjust the tire's pressure until an efficient tire contact patch, as indicated by the system's rotation count is within range of a target tire contact patch size (or, in example embodiments, a proxy in the form of number of rotations per a fixed distance). The range of acceptable contact tire patch sizes and their rotation proxies may be preset, for example at plus or minus two rotations per mile or in other embodiments at plus or minus one rotation per mile or in yet other embodiments at plus or minus one half rotation per mile. Upper and lower pressure bounds, as previously noted, may also be employed in accordance with principles of inventive concepts to ensure that pressures do not fall outside recommended safe operating ranges.

In example embodiments a system may dynamically adjust (for example, adjust during a vehicle's operation) target inflation pressures according to road surface conditions, including but not limited to: surface traction/slipperiness, surface roughness, or the number and tightness of turns in a road. As previously indicated, road conditions and other conditions may be provided from external sources (for example, by a travel service, by governmental weather or travel services, crowdsourced by other vehicles, by a fleet dispatch service, etc., through an electronic communication link) or by onboard detection within a system in accordance with principles of inventive concepts. In example embodiments a system may determine the slipperiness of a road surface by analyzing data from a three axis accelerometer sensor that may be interpreted by the system to determine whether there is lateral motion or jerking (when pavement alternates between wet and dry), for example. In example embodiments a system may analyze differences in tire revolutions for tires on the same side of a vehicle over a set period of time to determine slipperiness. In example embodiments a system may respond to driver input, for example, if a driver senses or anticipates slippery road conditions. “Dynamic control” may refer herein to control that is not only closed-loop, in that it responds to feedback from one or more sensors or other control feedback mechanisms but is also responsive to inputs that may adjust control targets, such as a target tire pressure. As a result, employing dynamic control in example embodiments a system may be responsive to an input by adjusting a target value that is the object of control. For example, a system may be responsive to external or internal input to modify a target tire pressure and control a compressed gas (air or other gas) supply (centralized tank system or distributed compressor system) to provide compressed gas at an updated target level. In example embodiments, the updated target value may be controlled to without direct manual intervention and may be implemented while a vehicle is in operation.

By way of example, if a system-related vehicle has four outer tires on a passenger side that are all of the same size, with an optimal inflation that yields 525 revolutions per mile, and a system in accordance with principles of inventive concepts detects lateral motion in the rear wheel-end systems (indicating that a trailer may be swaying), and the system determines that the revolutions over a set period of time (forty-five seconds, for example) is 350 for front tires and 340 for rear tires, the system may dynamically decrease the tire pressure to increase the tire surface contact patch in order to improve road grip for the relevant tires. As previously indicated, such an adjustment may also be made by a driver through an electronic interfaced, such as a Bluetooth link, should the driver sense or anticipate slippery conditions.

For rough road surfaces, which may cause skipping of a tire, in example embodiments a system may adjust the tire pressure (increase or decrease) to control (decrease or increase) the surface contact patch, for example, to compensate for rough surface conditions until a smoother surface is encountered. For a winding road, in example embodiments a system may employ data from a multi-axis accelerometer to sense the relative “windiness” of a road and adjust tire pressure to, for example, increase tire pressure and thereby reduce wear, or decrease pressure, within a range, to increase friction, with all adjustments being on a tire by tire or wheel-end by wheel-end basis. In example embodiments, a “straight, smooth, non-slippery” road condition may be used as a default condition, with dynamic pressure adjusted, simply, for the optimal tire pressure based on the load to optimize the tire contact patch based as previously described.

In example embodiments any dynamic pressure adjustment mode may be entered manually or may be automatically triggered and because, in example embodiments, a vehicle may include wheel-end units on a plurality of wheel ends and those wheel end units may communicate with one another or with a central unit to coordinate adjustments, vehicle-wide dynamic adjustments (that is, during vehicle operation) may be made. Dynamic pressure adjustment made also be incorporated as a system variable used by Vehicle Dynamic Handling Systems or other driver assist or autonomous driving systems.

As previously described, other adjustment processes, such adjustments to environmental conditions are also contemplated within the scope of inventive concepts. For example, it may be desirable to decrease the tire contact patch size at the road interface when the tires are hottest. In example embodiments a system includes integrated temperature sensor to detect ambient conditions and may increase tire pressure, thus decreasing the tire contact patch sized when the temperature rises above a threshold level. Conversely, when cooler temps are detected, there may be an advantage to deflating the tires some thus increasing the contact patch (to help ensure good road contact in anticipation of slippery conditions, for example), and in example embodiments a system may decrease tire pressure to compensate for cold conditions. Other scenarios, including decreasing pressure for high ambient temperatures or increasing pressure for low ambient temperatures are contemplated within the scope of inventive concepts.

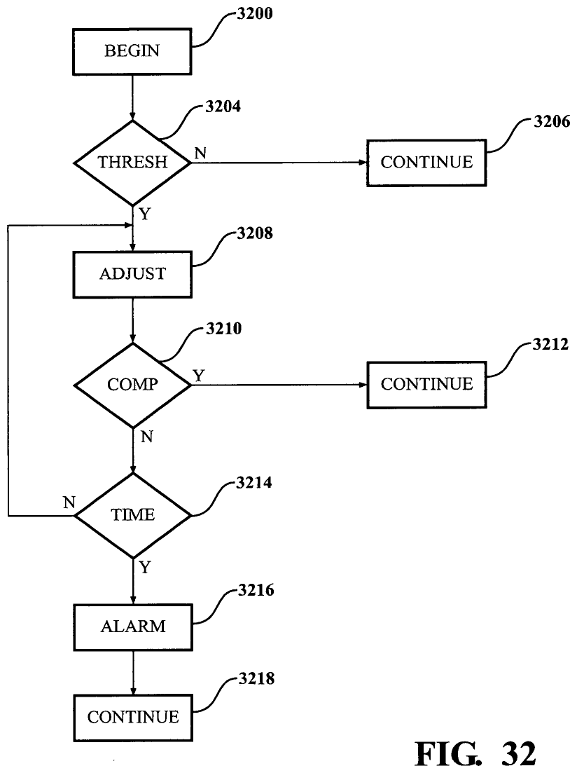

An example embodiment of a dynamic pressure adjustment process in accordance with principles of inventive concepts is illustrated by the flow chart of FIG. 32, which begins in step 3200 and proceeds to step 3204, where a system determines whether a threshold condition pertains to one or more tires of a vehicle associated with a system in accordance with principles of inventive concepts. Such conditions may be any of, but are not limited to, conditions described above, including load conditions, road conditions or environmental conditions and a threshold may be detected by internal, onboard analysis by the system or may be provided from an external source, as previously described. If no threshold condition pertains (for example, no load threshold for any tire, no road surface condition thresholds, no environmental threshold is met) the process proceeds to step 3206, where it continues. If, in step 3204 the process determines that a threshold condition does pertain, the process proceeds to step 3208, where the system adjusts a tire pressure as previously described. From step 3210, the process proceeds to step 3210 where the system determines whether the pressure adjustment has adequately compensated for the threshold event (for example, whether the rotation/distance is within a threshold range of a target value). If the pressure adjustment has compensated for the threshold event, the process proceeds to step 3212, where it may continue. If it is determined in step 3210 that the pressure adjustment has not adequately compensated for the threshold event, the process proceeds to step 3214, where it is determined whether the threshold condition is not being adequately compensated for, as indicated by a “timeout,” high-attempt-count or other end-of-compensation attempt event. If attempts at compensation are judged by the system to be inadequate, the process proceeds to step 3216 where a notification or alarm may be provided before the process proceeds to end or continue in step 3218. In addition to setting an alarm or notification in step 3216, the system may continue to provided pressure adjustment compensation. If, in step 3214, the process has not timed out, the process may return to step 3208 and on from there as previously described.

Tire Maintenance

In example embodiments, the history of a given tire may be determined by recording a number of attributes such as speedometer, temperature, and odometer data per hub. A system in accordance with principles of inventive concepts, with wheel-end units on each hub, allows the determination of miles traveled, temperature over a target, impacts over a target, number of non-permeation related air losses, tire location on rig, etc. The cataloguing of tire location and installation date/time in accordance with principles of inventive concepts provides the optimal maintenance tracking and performance for each tire. Based on the data accumulated, prescriptive maintenance such as tire rotation, wheel balancing, etc. can be performed to optimize the life/value of a given tire. In example embodiments total Tire Maintenance (Mileage, Rotation, Retreads, Position, Etc.) can be handled for each tire on the rig.

Retreadeability

In example embodiments data gathered by a system in accordance with principles of inventive concepts may be used by the system to identify and report on a tire's suitability for retreading. By continually monitoring a tire for proper inflation and the proper rotation of tires a system in accordance with principles of inventive concepts may increase tread life, as described herein, and may reduce the cumulative damage to the sidewalls, thereby increasing the likelihood of the retreadability of the tire carcass. In example embodiments a system may maintain a history of a tire and provide a recommendation as to the suitability of a tire for retreading, by, for example, comparing the tire's history to one or more suitability standards, such as tables, charts, or classifiers, for example. Although a visual inspection may be required in the final analysis, the system may provide a preliminary indication by tracking the tire's pressure and temperature history to provide information on difficult to determine cumulative damage due to flexing and heat as indicated by the tire temperature and pressure history. In example embodiments, “out of bounds” readings and their duration may be recorded over the life of a tire. For example, a history may indicate that the tire pressure never fell below 70 psi while the tire was in motion past 25,000 miles or, the that the tire pressure averaged 91 psi over the last 25,000 miles, or that the tire pressure was below a threshold level (for example an “ideal” pressure) over the past 25,000 miles but still within manufacturer's recommendations, or that the system recorded 216 impacts associated with the tire over the past 25,000 miles, with none of the impacts exceeding eight gs, for example.

Leak Rate

In example embodiments, a system in accordance with principles of inventive concepts may assess a tire leak and assign any of a plurality of proposed remedies based on the leak rate and refill frequency, as detected by the sensors, by the fill rate of the compressor into the tire and by the frequency of refill. In example embodiments, tire pressure monitoring and replacement air monitoring may allow tire assessments with appropriate alerts as follows:

Normal air leakage due to permeation, dynamic escape, etc.

Slow air leak, manageable for a moderate period of time

Moderate air leakage manageable for a short time, possibly the completion of the current trip

Large Leak Requiring Immediate Attention

Extreme Leak Requiring Immediate Stop

This information may provide a much earlier understanding of tire leakage and allow remedies to be applied when leaks are small and easily repaired. Without this sensing ability leaks may progress to larger leaks before identified and could result in a greater frequency of roadside breakdowns.

Road Hazard Reporting

In example embodiments, the assessment of the state of a roadway and the potential for damaging cargo or a vehicle may be determined by analysis of acceleration data by a system in accordance with principles of inventive concepts. As described herein, a system in accordance with principles of inventive concepts may employ acceleration profiles to distinguish acceleration sources from one another and roadway hazards, such as potholes may similarly be distinguished from other acceleration-inducing phenomena. In example embodiments, a GPS unit may be employed to correlate an acceleration event with the location of the event. The location and severity of the event (that is, the road hazard) may be recorded or reported to an appropriate governmental entity for repair. Reports may also be provided to users (to alert travel service subscribers to road hazards) or to travel industry organizations, for example. A system may record a reporting time and date and, if repeated events occur at the location, indicating a lack of repair within a designated time allotment, a claim may be filed with a responsible agency (for example, a municipality, state, department of transportation) for damages.

Self Diagnosis

A wheel-end unit in accordance with principles of inventive concepts may diagnose its own health and performance through a variety of diagnostic processes either internal to the unit itself or by assessing versus the performance of adjacent axle or cross axle units

For example, a wheel-end unit may diagnose air filter status by determining the fill rate of the tire vs. revolutions will provide an indication of the amount of air resistance in the filter. In example embodiments, once the efficiency drops to a pre-assessed level, an alert to change filter may be sent.

A wheel-end unit may diagnose battery charge by continually monitoring the charge state and battery charging will occur as needed. To facilitate efficient battery charging, compartment temperatures may be monitored and increased by a power generator-supplied heating elements when ambient temperature falls below optimal charging temperatures. The charge frequency may also be monitored. Should charge levels or charge rates fall below targets, alerts to replace the battery may be sent to users.

A wheel-end unit may diagnose pumping status by assessing the pumping pressure change when comparing to theoretical pressure change over time pumping and comparing to adjacent wheel-end units on a vehicle, for example. Various assessments regarding pump performance can be assessed and actions taken. As an example, if air temperatures are low and dew points present a potential freeze situation, hampering valve operation, power from the generator may be used to heat the valve seats and/or orifices.

A wheel-end unit may diagnose sensor by periodically comparison to the appropriate on unit, cross-axle and/or adjacent axle sensor values. If they differ, a set protocol to reset and/or alert the need for recalibration will be sent.

A wheel-end unit may diagnose inertial torque monitoring using a hall sensor, for example, to monitor the proper quasi-stationary position of the inertial arm, (also referred to herein as a quasi stationary element or pendulum). If the inertial arm begins to rotate beyond a predetermined rotational angle, selective adjustment of torque demand on the inertial arm may be performed. Actions such as temporarily curtailing electric power generation, selectively powering of mechanical systems via electrical methods, etc. If the inertial arm is monitored to traverse 360 degrees, shut off the compressor for a period of time to “settle” the pendulum may occur, then turn on of the compressor may occur with minimal other torque demands onto the inertial arm. As example, if the same rotation occurs again, follow the shut off protocol and for the next compressor initiation shunt the generator prior to actuating the compressor.

A wheel-end unit may diagnose power generation performance by continually monitoring the generate voltage, which will ensure the health of the generating system and identify any anomalies at an early state in their inception. The monitoring of voltage also may be used in conjunction with other sensing elements of the system.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A vehicle tire inflation system, comprising:
a central gas supply system configured for distribution of inflation gas to a vehicle tire; and
a distributed gas supply system configured for compressing gas and supplying the compressed gas to a vehicle tire.

2. The vehicle tire inflation system of claim 1, wherein the central gas supply system comprises a storage tank for holding compressed gas to be distributed to a vehicle tire.

3. The vehicle tire inflation system of claim 1, wherein the central gas supply system and distributed gas supply system are configured to supply compressed gas to the same vehicle tire.

4. The vehicle tire inflation system of claim 1, wherein the central gas supply system and distributed gas supply system are each configured to supply compressed gas to a plurality of vehicle tires.

5. The vehicle tire inflation system of claim 2, wherein a wheel-end supporting a tire configured to receive compressed gas from a central gas supply system includes a rotary valve for transfer of compressed gas from the storage tank to a vehicle tire.

6. The vehicle tire inflation system of claim 5, wherein the distributed gas supply system includes a compressor configured to compress air and to supply the compressed air to a vehicle tire.

7. The vehicle tire inflation system of claim 1, wherein the system includes a manifold for distribution of compressed air from a compressor and compressed gas from a storage tank to a vehicle tire.

8. The vehicle tire inflation system of claim 7, further comprising:
a sensor; and
a controller, wherein the sensor and controller are configured for attachment to a wheel-end that supports a tire configured for inflation by the tire inflation system.

9. The vehicle tire inflation system of claim 8, wherein the sensor is configured to sense a characteristic of the wheel-end or tire attached thereto.

10. The vehicle tire inflation system of claim 9, wherein the controller is configured to control operation of the compressor.

11. A vehicle tire inflation system, comprising:
a central gas supply system configured for distribution of compressed inflation gas to a plurality of vehicle tires; and
a distributed gas supply system configured for compressing gas and supplying the compressed gas to a plurality of vehicle tires, wherein the distributed gas supply system comprises a plurality of compressors, one for each wheel-end of the vehicle that supports a tire configured for inflation by the inflation system, and a plurality of controllers, one for each compressor, each controller configured to control one of the compressors.

12. A method of inflating a vehicle tire, comprising:
providing a central gas supply system configured for distribution of inflation gas to a vehicle tire; and
providing a distributed gas supply system configured for compressing gas and supplying the compressed gas to a vehicle tire.

13. The method of inflating a vehicle tire of claim 12, wherein the central gas supply system comprises a storage tank distributes compressed gas to a vehicle tire.

14. The method of inflating a vehicle tire of claim 12, wherein the central gas supply system and distributed gas supply system supply compressed gas to the same vehicle tire.

15. The method of inflating a vehicle tire of claim 12, wherein the central gas supply system and distributed gas supply system are each supply compressed gas to a plurality of vehicle tires.

16. The method of inflating a vehicle tire of claim 13, wherein compressed gas is transferred from a storage tank to a wheel-end supporting a tire and to a tire through a rotary valve coupled to the wheel-end.

17. The method of inflating a vehicle tire of claim 16, wherein a compressor in the distributed gas system compresses air to supply the compressed air to a vehicle tire.

18. The method of inflating a vehicle tire of claim 12, wherein the system distributes compressed gas from a storage tank and compressed air from a compressor through a manifold to includes a vehicle tire.

19. The method of inflating a vehicle tire of claim 18, further comprising:
providing a sensor and controller for attachment to a wheel-end that supports a tire configured for inflation by the tire inflation system.

20. The method of inflating a vehicle tire of claim 19, wherein the sensor senses a characteristic of the wheel-end or tire attached thereto and the controller controls operation of the compressor.
